(19) United States
(12) Patent Application Publication
(10) Pub. No.: US 2025/0158745 A1
(43) Pub. Date: May 15, 2025

(54) REPETITION MODE CONTROL AND COMMUNICATION SIGNAL REPETITION IN A WIRELESS NETWORK

(71) Applicant: Charter Communications Operating, LLC, St. Louis, MO (US)

(72) Inventors: Nima Namvar, Charlotte, NC (US); Maulik V. Vaidya, Escondido, CA (US); Dumitru M. lonescu, Poway, CA (US); Abdulrauf Hafeez, Cary, NC (US); Mehdi Ganji, Santa Rosa, CA (US); Mojtaba Ahmadi Almasi, Portland, OR (US); Muhammad Usman Fazili, Audubon, PA (US); Aditi Singh, San Diego, CA (US)

(21) Appl. No.: 18/410,530

(22) Filed: Jan. 11, 2024

Related U.S. Application Data
(60) Provisional application No. 63/598,769, filed on Nov. 14, 2023.

(51) Int. Cl. H04L 1/08; H04W 72/1263

(52) U.S. Cl. CPC H04L 1/08; H04W 72/1263

(57) ABSTRACT

A communication management resource receives input indicating a quality of a wireless communication link between a first wireless station and a second wireless station. Based on detected degradation of the quality of the wireless communication link as indicated by the input, the communication management resource dynamically implements an appropriate repetition mode of repeatedly transmitting data from the first wireless station to the second wireless station. The second wireless station can be configured to receive a repetition settings notification from the first wireless station or other suitable entity. The repetition settings notification specifies operation of the first wireless station in a repetition mode in which the first wireless station is configured to repeatedly transmit data from the first wireless station over a wireless communication link to the second wireless station. Operation in the repetition mode enables the first wireless station to continue communications with the second wireless station.

This application claims the benefit of earlier filed U.S. Patent Application Ser. No. 63/598,769 entitled “REPETITION MODE CONTROL AND COMMUNICATION SIGNAL REPETITION IN A WIRELESS NETWORK,” (Attorney Docket No. CHTR-2023-157P), filed on Nov. 14, 2023, the entire teachings of which are incorporated herein by this reference.

### BACKGROUND

Modern mobile devices, such as smartphones and tablets, are equipped with batteries of limited capacity. In order to optimize power consumption, their radio transmissions are typically capped at around 15 mW (12 dBm). In contrast, APs (Access Points) can transmit at higher power levels: up to 100 mW (20 dBm) on the 2.4 GHz band and 200 mW (23 dBm) on the 5 GHz band.

The effectiveness of a respective wireless connection isn't solely determined by the client's ability to receive signals from the AP (Access Point); rather, it relies on the AP's capacity to receive signals from the client communication device as well. This concept underscores why a mobile communication device might have encountered situations where a seemingly strong signal from a wireless access point doesn't translate into a functional connection.

Moreover, the bidirectional nature of Wi-Fi™ communication maintains symmetry, rendering factors such as antenna quality and location relevant in both directions. For instance, an enhanced antenna and strategic positioning of the antenna can bolster the connection's performance in both sending and receiving data. On the contrary, a unilateral increase in transmit power only influences one side of the connection.

Unlike mobile telephone networks (such as a cellular network), where base stations dictate client connections, a wireless communication protocol such as Wi-Fi™ empowers client devices to select and roam between APs or switch to an external network, e.g. cellular network.

In Wi-Fi™ communication systems, associations are persistent. Wi-Fi™ devices exhibit a resilient tendency to maintain their association with a particular AP as long as an acceptable RSSI (Received Signal Strength Indicator or received wireless signal) is observed in the DL (Downlink). Only when the current connection becomes entirely unstable does a respective management resource associated with the communication device consider switching to an alternative AP or to a different network such as a cellular network.

This association tenacity often leads to an time delayed handoff of the current connection—which requires (dis/re) Association—and transitioning the connection to an external network. Thus, after the client mobile communication device moves far away from the access point, its wireless Tx power can no longer maintain an UL coverage to the wireless access point. The circumstance and hesitation to transfer (handoff) to an external network or another AP often leads to a disconnection of the mobile communication device with respect to the wireless access point. This is akin to the mobile communication device being stranded in a connectivity void, in which the mobile communication device is unable to communicate with any wireless access point.

### BRIEF DESCRIPTION OF EXAMPLES

This disclosure further includes the observation that certain wireless systems exhibit inherent UL/DL (Uplink/Downlink) Power transmit asymmetry. For example, a wireless access point typically transmits at a substantially higher power level in the downlink direction than a mobile communication device transmits in the uplink direction to the wireless access point. Consequently, a situation may arise in which the mobile communication device may be within range to receive wireless communications transmitted from the wireless access point, but the mobile communication device may not be able to communicate at a sufficiently high transmit power level to communicate with the wireless access point. In such an instance, the wireless connectivity between the wireless access point in the mobile communication device does not support bidirectional communications. This provides poor quality of service to the mobile communication device.

As a more specific example, a mobile device operated in the network environment may display a single bar of signal strength indicating a respective power level of the mobile communication device receiving wireless communications from a wireless access point. However, the mobile communication device may experience difficulties making phone calls or accessing the internet via communications in the uplink. In this case, the mobile communication device is capable of receiving wireless communications from the wireless access point but is unable to effectively communicate in the uplink to the wireless access point.

In contrast to conventional techniques, the communication system and operations as described herein provide better wireless connectivity and more efficient use of wireless bandwidth in a respective network environment of multiple users sharing a respective bandwidth such as one or more wireless channels.

More specifically, in accordance with one example, a network environment includes a communication management resource. The communication management resource can be disposed in any location in the network environment such as in one or more of a first wireless station, a second wireless station, or elsewhere. The communication management resource can be configured to receive input indicating a quality of a wireless communication link between a first wireless station and a second wireless station. Based on detected degradation of the quality of the wireless communication link as indicated by the input, the communication management resource and corresponding wireless stations can be configured to implement a repetition mode of repeatedly transmitting data from the first wireless station to the second wireless station as needed.

As further discussed herein, note that the input such as indicating degradation of a respective wireless communication link (uplink and downlink degradation) can be received from any suitable entity. In one example, the input indicating the quality of the wireless communication link experienced by the second wireless station can be received from the second wireless station, the first wireless station or other suitable entities. If desired, the input can further notify the first wireless station to operate in the repetition mode because communications from the first wireless station are not properly received by the second wireless station.

In accordance with further examples, the first wireless station or other suitable entities can be configured to produce the input indicating the link quality degradation in response to an inability of the first wireless station to receive wireless signals from the second wireless station above a wireless power level.

More specifically, the first wireless station can be configured to determine a condition under which the first wireless station is not able to communicate with the second wireless station or at least that the uplink transmission from the first wireless station to the second wireless station is poor based upon a received power level of the second wireless station receiving wireless signals from the first wireless station. In other words, the wireless signal generated by the first wireless station and received by the second wireless station may be below a threshold level. If desired, the first wireless station can be configured to notify the second wireless station regarding operation of the first wireless station in a repetition mode in which the first wireless station repeatedly transmits data to the second wireless station on an as-needed basis. As further discussed herein, the result of operating in the repetition mode and repeatedly transmitting the data from the wireless station over the wireless communication link to the second wireless station increases a wireless transmit range of the first wireless station.

Note further that the repetition mode can be configured to operate in the time domain. In such an instance, the first wireless station repeatedly transmits the data over the wireless communication link in the time domain. This can include, in a first time duration (such as a first timeslot), the first wireless station transmitting a first instance of the data over the wireless communication link from the first wireless station to the second wireless station. Additionally, this can include, in a second time duration (such as a second timeslot) such as following the first time duration, the first wireless station transmitting a second instance of the data over the wireless communication link from the first wireless station to the second wireless station. In accordance with the repetition mode, the second instance of the data is a replica of the first instance of the data. In other words, the first wireless station transmits the same data to the second wireless station, but in different time slots.

In a further example, during frequency repetition, the first instance of the data is transmitted from the first wireless station to the second wireless station over a first wireless bandwidth such as one or more wireless channels; the second instance of the data is transmitted from the first wireless station to the second wireless station over the first second wireless bandwidth such as one or more wireless channels. The first wireless station and the second wireless station can be operated in a clear channel assessment system in which each of the first wireless station and the second wireless station must implement a listen before talk function in order to acquire the first wireless bandwidth prior to transmission of communications. In one example, as previously discussed, the first wireless station transmits the first instance and the second instance of the same data over the first wireless bandwidth. The first time duration and the second time duration of transmitting the same data may reside within a single acquisition of the first wireless bandwidth by the first wireless station.

As an alternative to transmitting the same data over two different time durations of a single acquisition of the first wireless bandwidth, the first duration of the first wireless station transmitting the first instance of the data can be configured to occur within a first acquisition of the first wireless bandwidth by the first wireless station. The second duration of the first wireless station transmitting the second instance of data can be configured to occur within a second acquisition of the first wireless bandwidth by the first wireless station. Thus, the same data can be transmitted over multiple different TXOPs. As further discussed herein, a TXOP corresponds to a condition in which a wireless station has acquired rights to use a respective channel.

In accordance with further examples, implementation of the repetition mode may include repeating transmission of the data from the first wireless station over the wireless communication link in the frequency domain. For example, repeated transmission of the data in the frequency domain may include: via a first wireless carrier frequency, transmitting a first instance of the data over the wireless communication link from the first wireless station to the second wireless station; and via a second wireless carrier frequency different than the first wireless carrier frequency, transmitting a second instance of the data over the wireless communication link from the first wireless station to the second wireless station.

As further discussed herein, frequency repetition may include a condition in which the carrier frequency is not different for two replicas. For example, a same carrier frequency may be used and only data is replicated in two adjacent frequency blocks. For example, a carrier frequency Fc of 5 GHz may encompass a BW (Bandwidth) of 40 MHz, and techniques herein include just repeating the data in two consecutive 20 MHz blocks using a same Fc.

Still further examples as discussed herein include the first wireless station or other suitable entity transmitting a repetition settings notification from the first wireless station to the second wireless station. The repetition settings notification can be configured to specify how many instances in which the data associated with the first wireless station is scheduled to be repeatedly transmitted from the first wireless station to the second wireless station via the selected repetition mode specified by the repetition settings notification.

The repetition settings notification can be configured to indicate further information such as a type associated with the selected repetition mode such as specifying time domain repetition of data, frequency domain repetition of data, spatial domain repetition of data, multi-link option such as communications over 2.6 gigahertz, 5 gigahertz, 6 gigahertz, etc.

Yet further, the repetition settings notification as discussed herein can be configured to indicate whether the different instances of the replicated data communicated from the first wireless station and the second wireless station are transmitted in a single wireless bandwidth acquisition or multiple different wireless bandwidth acquisitions. For example, the information in the repetition settings notification can be configured to indicate that the first wireless station is configured to repeat transmission of multiple instances of the data in a single TXOP (Transmit Opportunity or channel acquisition) acquired by the first wireless station via a listen before talk function. Alternatively, the repetition settings notification can be configured to indicate that the first wireless station is configured to repeat transmission of the instances of the replicated data over multiple TXOPs (Transmit Opportunities were multiple channel acquisitions) acquired by the first wireless station via the listen before talk function.

Thus, in one example, the second wireless station receives one or more repetition settings notifications specifying operation of a first wireless station in a repetition mode in which the first wireless station is configured to repeatedly transmit data from the first wireless station over a wireless communication link to the second wireless station. In accordance with the repetition mode as specified by the repetition settings notification, the second wireless station configures itself to receive multiple instances of the data transmitted from the first wireless station over the wireless communication link.

As previously discussed, the second wireless station can be configured to determine a power level of receiving wireless communications from the first wireless station. Recall that the second wireless station is able to communicate with the first wireless station because it transmits at a high power level. The second wireless station can be configured to transmit a power level communication from the second wireless station to the first wireless station. The power level communication can be configured to indicate a received power level of the second wireless station receiving wireless communications from the first wireless station.

Via the power level information, the first wireless station can be made aware that the wireless transmissions from the first wireless station may not be received by the second wireless station. In response to detecting this condition, the first wireless station can be configured to implement the repetition mode, effectively increasing the wireless range of the first wireless station communicating with the second wireless station or other wireless stations in the network environment.

Thus, in one example, the first wireless station communicates the repetition settings notification to the second wireless station in response to detecting degradation of a quality of the wireless communication link to convey communications from the first wireless station to the second wireless station or vice versa.

Note further that the implementation of the repetition mode is dynamic. For example, the first wireless station and/or the second wireless station can be configured to operate in the repetition mode in response to detecting that one of the uplink or downlink suffers from a performance degradation (inability to convey data from one wireless station to another). If the performance of the respective uplink from the first wireless station to the second wireless station improves over time, the first wireless station can be configured to forgo or discontinue operating in the repetition mode and operate in a normal mode of communicating data in an uplink from the first wireless station to the second wireless station. In other words, if the performance of a respective uplink improves over time, there is no longer a need to operate in the repetition mode of extending a region of wireless coverage associated with the first wireless station to the second wireless station.

Yet further, the second wireless station can be configured to transmit a communication from the second wireless station to the first wireless station notifying the first wireless station to operate in the repetition mode. Thus, either of the first wireless station or the second wireless station can be configured to select operation of one or more of the wireless stations in the repetition mode.

Still further, the repetition settings notification as discussed herein can be configured to indicate scheduled repetition (also known as scheduled format) of transmitting the data over the wireless communication link from the first wireless station to the second wireless station in the time domain. In accordance with the received repetition settings notification, the second wireless station: i) in a first time duration, receives a first instance of the data transmitted over the wireless communication link from the first wireless station to the second wireless station; and ii) in a second time duration following the first time duration, receives a second instance of the data over the wireless communication link transmitted from the first wireless station to the second wireless station, the second instance of the data being a replica of the first instance of the data. As further discussed herein, the repetition settings notification can be configured to indicate how the first wireless station is scheduled to transmit the replicated data.

Yet further embodiments are discussed below.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), non-transitory computer-readable storage media, computer storage hardware, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium or computer readable hardware such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon to facilitate better use of available wireless resources.

The instructions, when executed by computer processor hardware, cause the computer processor hardware (such as one or more co-located or disparately processor devices or hardware) to: receive input indicating a quality of a wireless communication link between a first wireless station and a second wireless station; and based on detected degradation of the quality of the wireless communication link as indicated by the input, dynamically implement a repetition mode of repeatedly transmitting data from the first wireless station to the second wireless station.

Another example as discussed herein includes computer-readable storage hardware having instructions stored thereon, the instructions, when carried out by computer processor hardware, cause the computer processor hardware to: receive a repetition settings notification, the repetition settings notification specifying operation of a first wireless station in a repetition mode in which the first wireless station is configured to repeatedly transmit data from the first wireless station over a wireless communication link to the second wireless station; and in accordance with the repetition mode as specified by the repetition settings notification, receive multiple instances of the replicated data transmitted from the first wireless station over the wireless communication link.

Note that the ordering of the steps above has been added for sake of clarity. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless communication services and better use of available wireless bandwidth. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment including multiple wireless stations in communication with each other as discussed herein.

FIG. 2 is an example diagram illustrating movement of a first wireless station with respect to a second wireless station and expansion of a region of wireless coverage associated with the first wireless station to communicate with the second wireless station as discussed herein.

FIG. 3 is an example diagram illustrating implementation of a repetition mode in order to increase a region of wireless coverage associated with a wireless station as discussed herein.

FIG. 4 is an example diagram illustrating implementation of the repetition mode and corresponding coherency detection function as discussed herein.

FIG. 5 is an example diagram illustrating configuration information included in a repetition settings notification as discussed herein.

FIG. 6 is an example diagram illustrating different possible partitioning applied to an acquired wireless bandwidth or channel as discussed herein.

FIG. 7 is an example diagram illustrating operation of wireless system and corresponding wireless stations in a frequency domain repetition mode as discussed herein.

FIG. 8 is an example diagram illustrating operation of a wireless system in a first time domain repetition mode as discussed herein.

FIG. 9 is an example diagram illustrating operation of a wireless system in a second time domain repetition mode as discussed herein.

FIG. 10 is an example diagram illustrating operation of a wireless system in a combination time domain and frequency domain repetition mode as discussed herein.

FIG. 11 is an example diagram illustrating example computer architecture operable to execute one or more operations according to examples herein.

FIG. 12 is an example diagram illustrating a method as discussed herein.

FIG. 13 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A communication management resource and corresponding wireless station receive input indicating a quality of a wireless communication link between a first wireless station and a second wireless station. Based on detected degradation of the quality of the wireless communication link as indicated by the input, the communication management resource implements a repetition mode of repeatedly transmitting data from the first wireless station to the second wireless station. The second wireless station can be configured to receive a repetition settings notification from the first wireless station or other suitable entity. The repetition settings notification specifies operation of the first wireless station in a repetition mode in which the first wireless station is configured to repeatedly transmit data from the first wireless station over a wireless communication link to the second wireless station. Operation in the repetition mode enables the first wireless station to continue communications with the second wireless station as opposed to dropping a respective wireless communication link in response to degradation of performance of the wireless communication link.

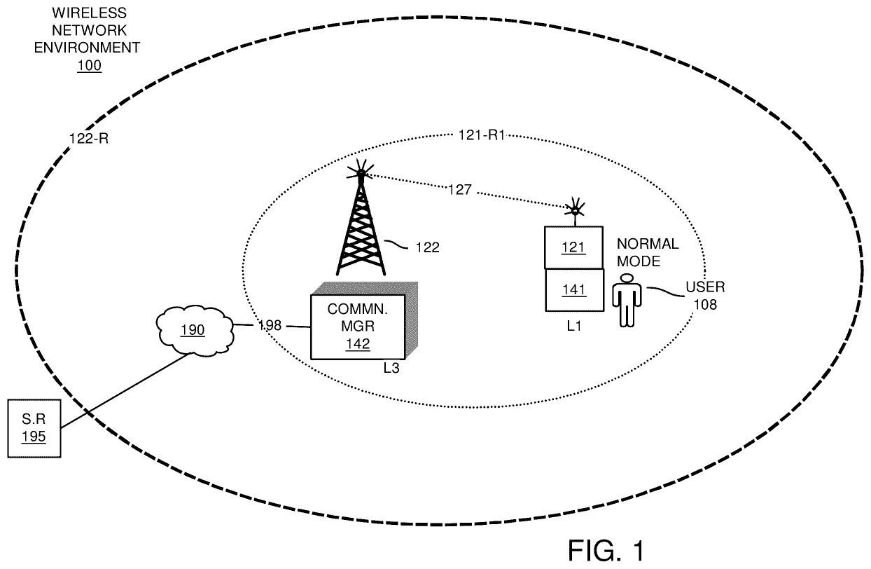

Now, more specifically, with reference to the drawings, FIG. 1 is an example diagram illustrating a network environment including multiple wireless stations in communication with each other as discussed herein.

As shown, network environment 100 includes a first wireless station 121 (such as a mobile communication device, user equipment, etc.) and a second wireless station 131 (such as a wireless access point, wireless base station, mobile communication device, etc.).

The first wireless station 121 includes communication management resource 141. As its name suggests, the communication management resource 141 manages operation of the first wireless station 121.

The second wireless station 122 includes communication management resource 142. As its name suggests, the communication management resource 142 manages operation of the second wireless station 122.

The wireless communication link 127 between the wireless station 121 and the wireless station 122 can be configured to support conveyance of corresponding data between the wireless station 121 at location L1 and the wireless station 122 at location L3. The wireless station 121 and the wireless station 122 can be configured to communicate over the wireless communication link 127 in accordance with any suitable protocol such as Wi-Fi™, cellular protocol (such as New Radio, 3G, 4G, 5G, etc.). In this example, the wireless station 122 supports region of wireless coverage 122-R. In such an instance, the wireless station 122 is able to communicate in a respective downlink direction with any wireless stations disposed in the region of wireless coverage 122-R. Since the wireless station 121 resides in the region of wireless coverage 122-R, the wireless station 121 and corresponding communication management resource 141 are able to receive downlink communications transmitted from the wireless station 122 over the wireless communication link 127 to the wireless station 121.

In this example, when the wireless station 121 and corresponding communication management resource 141 are operated in the normal mode (non-repetition mode), the wireless station 121 supports region of wireless coverage 121-R1 via wireless signals transmitted from the wireless station 121. In such an instance, because the wireless station 122 resides within the region of wireless coverage 121-R 1, the wireless station 121 is able to communicate in a respective uplink direction with the wireless station 122.

As further shown in FIG. 1, there is a mismatch in the wireless power levels transmitted by each of the wireless station 121 and the wireless station 122. For example, the wireless station 122 may be a corresponding wireless access point or wireless base station transmitting at a first wireless power transmit level to provide the region of wireless coverage 122-R. The wireless station 121 may be a corresponding mobile communication device or user equipment transmitting at a second wireless power transmit level. The second wireless power level is less than the first wireless power level. In such an instance, the region of wireless coverage 122-R provided by the wireless station 122 is greater in size than the region of wireless coverage 121-R1 provided by the communication device 121.

The wireless station 121 may be a corresponding mobile communication device operated by a respective user 108 to access the corresponding remote network 190 and server resource 195 in the uplink direction via wireless communications transmitted from the wireless station 121 over the wireless communication link 127. The wireless station 122 forwards the received communications over the communication link 198 through network 190 to the server resource 195.

Additionally, the wireless station 121 receives downlink communications transmitted from the server resource 195. For example, the server resource transmits communications through the network 190 and/or the communication link 198 to the communication management resource 142 and corresponding wireless station 122. The wireless station 122 then wirelessly transmits the downlink communications over the wireless communication link 127 to the wireless station 121 and the corresponding communication management resource 141.

Note that each of the resources in network environment 100 can be configured to include or be configured as appropriate hardware, software, or combination of hardware and software to carry out respective operations as discussed herein.

For example, the wireless station 121 as described herein can be implemented via respective wireless station hardware, wireless station software, or a combination of wireless station hardware and wireless station software; communication management resource 141 as described herein can be implemented via respective communication management hardware, communication management software, or a combination of communication management hardware and communication management software; the wireless station 122 as described herein can be implemented via respective wireless station hardware, wireless station software, or combination of wireless station hardware and wireless station software; communication management resource 142 as described herein can be implemented via respective communication management hardware, communication management software, or combination of communication management hardware and communication management software; and so on.

As further discussed herein, during conditions in which the wireless station 121 is unable to wirelessly transmit communications to the wireless station 122, the wireless station 121 and corresponding communication management resource 141 are switched over from operating in the normal mode to operating in a so-called (data) repetition mode to increase the effective wireless coverage of the wireless station 121 communicating with the wireless station 122 or any other wireless station in the network environment 100.

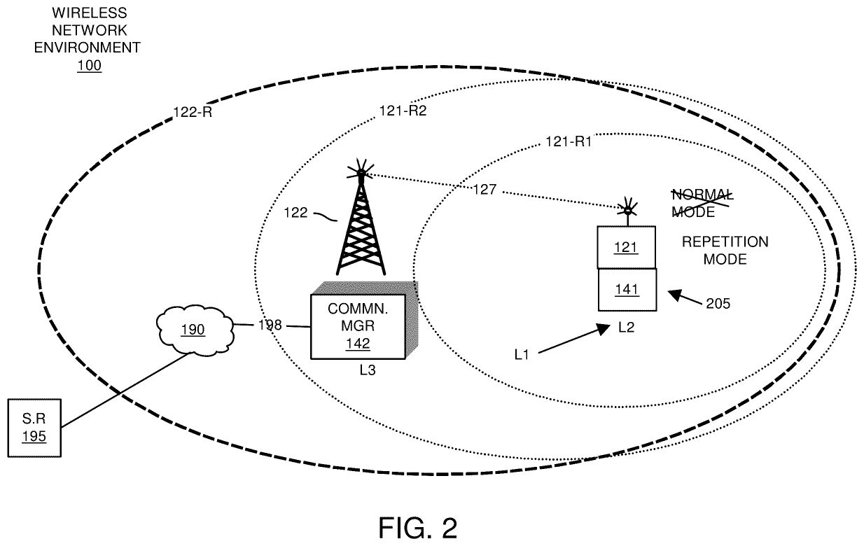

FIG. 2 is an example diagram illustrating movement of a first wireless station with respect to a second wireless station and expansion of the region of wireless coverage associated with the first wireless station to support wireless connectivity as discussed herein.

As previously discussed, while the wireless station 121 is located at the location L1, the wireless station 121 is able to operate in the normal mode and wirelessly communicate in the uplink direction over the wireless medications 127 to the wireless station 122. However, assume that the wireless station 121 moves to location L2 as shown in FIG. 2 and still operates in the normal mode such as a non-repetition mode of transmitting data over the wireless communication link 127 to the wireless station 121. In such an instance, while operating in the normal mode, the wireless station 121 is unable to wirelessly communicate with the wireless station 122. For example, the wireless station 122 resides outside of the region of wireless coverage 121-R1 provided by the wireless station 121 operating in the normal mode.

The wireless station 121 can be configured to learn of the inability to communicate with the wireless station 122 in any suitable manner. For example, the wireless station 121 can be configured to transmit wireless communications to the wireless station 122 and corresponding communication management resource 142. The wireless station 121 and corresponding communication management resource 141 can be configured to determine the inability or degraded ability to wirelessly communicate with the wireless station 122 based on detecting failure of receiving a respective acknowledgment communication from the wireless station 122 associated with a prior transmitted communication from the wireless station 121 to the wireless station 122.

Additionally, or alternatively, the wireless station 121 can be configured to receive notification of the wireless power level at which the wireless station 122 receives wireless communications from the wireless station 121. For example, the wireless station 122 can be configured to communicate the wireless power level information (indicating the wireless power level) over the wireless communication link 127 to the wireless station 121. In such an instance, based on one or more communications from the wireless station 122 or other suitable entity, the wireless station 121 can determine a condition in which the wireless communication link 127 has degraded to a point where it is difficult or impossible for the wireless station 121 to wirelessly communicate in an uplink direction from the wireless station 121 to the wireless station 122 while the wireless station 121 is operated in the normal mode while at location L2.

As further discussed herein, the wireless station 121 and corresponding communication management resource 141 can be configured to receive input 205 indicating a quality of or a condition of the wireless communication link 127 between a first wireless station and a second wireless station. As previously discussed, the performance of the wireless communication link 127 to convey uplink communications as indicated by the input 205 can be received from any suitable entity such as the communication management resource 142, wireless station 132, wireless station 121, communication management resource 141, etc.

In accordance with one example, the communication management resource 141 produces the input 205 at the first wireless station 121 in response to an inability of the first wireless station 121 to receive wireless signals from the second wireless station 122 above a wireless power level.

Based on detected degradation of the quality of the wireless communication link to convey uplink communications from the wireless station 121 to the wireless station 122 as indicated by the input, the wireless station 121 and corresponding communication management resource 141 can be configured to switchover to implementing a repetition mode of repeatedly transmitting data from the first wireless station to the second wireless station in lieu of operating in the normal mode. As discussed during, the repetition mode effectively increases the size of the region of wireless coverage associated with the wireless station 121 from region of wireless coverage 121-R 1 to region of wireless coverage 121-R 2.

More specifically, operation of the wireless station 121 and corresponding communication management resource 141 in the normal mode results in the region of wireless coverage 121-R1. This wireless coverage (121-R1) is insufficient to enable the wireless station 121 to wirelessly communicate with the wireless station 122 as shown. Upon switchover of the wireless station 121 and corresponding communication management resource 141 to the repetition mode, the wireless station 121 now supports a corresponding larger region of wireless coverage 121-R2, which enables the wireless station 121 and corresponding communication management resource 141 to transmit wireless communications to the wireless station 122 and corresponding communication management resource 142. In other words, operation in the repetition mode as described herein results in an increase in the region of wireless coverage 121-R1 to the region of wireless coverage 121-R2.

Any suitable entity in the network environment 100 can be configured to notify the wireless station 121 and corresponding communication management resource 141 to operate in the repetition mode as an alternative to the normal mode.

For example, the wireless station 121 and corresponding communication management resource 141 can be configured to receive notification (such as a repetition settings notification) from the wireless station 122 and corresponding communication management resource to operate in the repetition mode as an alternative to operating the normal mode of receiving data from the wireless station 121 over the wireless communication link 127. Alternatively, the wireless station 121 and corresponding communication management resource 141 can be configured to switchover from the normal mode to the repetition mode in response to detecting degradation of the ability of the wireless station 121 to wirelessly communicate messages to the wireless station 122.

As previously discussed, the wireless station 122 and corresponding communication management resource 142 can be configured to receive notification (such as a repetition settings notification) from the wireless station 121 and corresponding communication management resource 141 to operate in the repetition mode as an alternative to the normal mode. The repetition mode of repeatedly transmitting the data from the first wireless station 121 to the second wireless station 122 as described herein increases a wireless transmit range of the first wireless station 121, making it possible for the wireless station 122 to receive the wireless communications transmitted by the wireless station 121. When the wireless station 121 operates in the repetition mode, the wireless station 122 also operates in the repetition mode to receive the repeatedly transmitted wireless data from the wireless station 121. The wireless station 121 and corresponding communication management resource 141 can be configured to notify the wireless station 122 and corresponding communication management resource 142 how the wireless station is going to repeatedly transmit the wireless data and uplink.

More specifically, the wireless station 121 can be configured to communicate a repetition setting notification to the wireless station 122 and corresponding communication management resource 142. The repetition settings notification specifies operation of wireless station 121 and the repetition mode in which the wireless station 121 is configured to repeatedly transmit data from the first wireless station 121 over the wireless medications link 127 to the wireless station 122.

In response to receiving the repetition settings notification, whether received from the wireless station 121 or other suitable entity, the wireless station 122 and/or the communication management resource 142 configures the second wireless station 122 and the configuration management resource 142 to receive multiple instances of the data in a manner specified by the repetition mode. In other words, the repetition settings notification can be configured to indicate a repetition format in which the data will be repeatedly transmitted over the wireless communication link 127 to the wireless station 122.

While both of the wireless station 121 and the wireless station 122 are operated in the repetition mode, the wireless station 121 repeatedly transmits multiple instances of the data from the first wireless station 121 to the second wireless station 122. As previously discussed, the repetition of transmitting the data increases a wireless transmit range of the first wireless station 121.

In accordance with the repetition mode as specified by the repetition settings notification, as further discussed herein, the wireless station 122 receives multiple instances of the data transmitted from the first wireless station 121 over the wireless medications 127.

Thus, a respective user 108 operating the wireless station 121 may move away from the wireless station 122 from location L1 to location L2 (such as a serving access point) during an active session (e.g., VoWi-Fi call or Web Browsing). The gradual degradation of the corresponding uplink associated with the wireless medications 127 may occur while the wireless station 121 potentially transitions from a Wi-Fi network to a cellular network or simply when the wireless station 121 stays connected to the Wi-Fi network. The temporary degradation results in degraded Quality of Experience (QoE) for the user operating the wireless station 121.

The challenges associated with the above condition include the wireless station 121 remaining connected to the wireless station 122 (such as serving AP) based on good RSSI (signal strength) in the downlink direction despite the absence of UL coverage from the wireless station 121 to the wireless station 122. In essence, although the wireless station 121 (device) remains “connected” to Wi-Fi and corresponding wireless station 122, the lack of bidirectional connectivity associated with the wireless communication link 127 renders the connection practically non-functional without implementation of the repetition modes as discussed herein.

Different repetition modes as described herein empower the wireless station 121 to be proactive about transition to a different wireless network. Such modes also improve the QoE of the wireless station 121 communicating with the wireless station 122 by optimizing Wi-Fi-to-cellular handover and mitigate the “no man's land” phenomenon.

As further discussed herein, the wireless system and implementation of the repetition modes improve the user's QoE during the transition from Wi-Fi to cellular network alternatively during conditions in which the wireless station 121 stays connected to the wireless access point (wireless station 122).

Note that the extended wireless coverage as described herein can be implemented in either the uplink direction or the downlink direction. For example, there may be cases where the wireless station 122 implements one or more repetition modes to extend the wireless coverage from the wireless station 122 to the wireless station 121. By expanding the UL coverage areas, client devices (STAs) such as wireless station 121 and the like are afforded additional time to evaluate and transition to another optimal AP, or even another network, seamlessly, thereby smoothening the coverage drop-off effect. As mentioned, the techniques herein also can be applied to downlink transmissions.

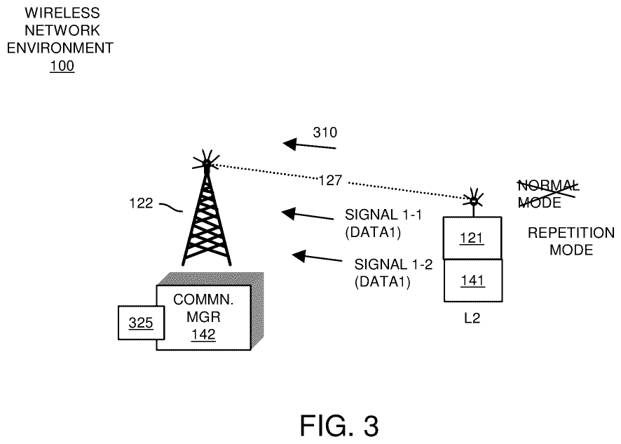

FIG. 3 is an example diagram illustrating implementation of a repetition mode in order to increase a region of wireless coverage associated with a wireless station discussed herein.

As its name suggests, one aspect of operating one or more of the wireless station 121 and the wireless station 122 in the repetition mode includes determining, via communication management resource 141 and/or communication management resource 142, a number of repetitions in which to repeat corresponding data transmitted from one wireless station to another.

For example, operation in repetition mode as discussed herein can be controlled or selected by one or more of the first wireless station 121 or the second wireless station 122 or even other suitable entity. The number of repetitions can be configured either by AP in AP-driven mode or by STA in STA-driven mode (a.k.a., station-driven mode).

### AP-Driven Mode:

In AP-driven mode, such as when the wireless station 122 and/or the communication management resource 142 control operation of the wireless stations in the repetition mode, because the wireless station 122 has knowledge of received SINR (signal-to-noise ratio from the wireless station 121) and the required SINR for decoding the corresponding MCS (Modulation Coding Scheme), wireless station 122 can be configured to calculate the number of required repetitions for operation of the wireless station 122 and the wireless station 121 in the repetition mode.

As an example, considering a 10 log (N) increase in SNR, N being the number of transmissions, the minimum number of required transmissions can be calculated by AP as:

$${N}_{transmissions} = max \{ ⌈ {10}^{\frac{{SNR}_{target} - {SNR}_{received}}{10}} ⌉ , 1 \}$$

The SNR values are in dB and the target SNR can be calculated based on previous transmissions of the same STA received by the AP which resulted in ACKs. If the target SNR (Signal-to-Noise Ratio) value SNR_{target} is not available at the wireless station 122 such as a wireless access point, the wireless access point can use the heuristic approaches stated below.

### STA-Driven Mode:

In a respective STA-driven mode in which the wireless station 121 determines which repetition mode to execute, if the STA (such as wireless station 121) does not have the information indicating a wireless power level of the wireless station 122 receiving wireless signals from the wireless station 121, the wireless station 121 can be configured to implement heuristic approaches such as:

1.) Resource-efficient approach: In this approach, STA (a.k.a., wireless station 121) progressively increases the number of repetitions from 1 by a configured value after receiving a NACK from the wireless station 122. For example, if the configured value is 2, the number of repetitions will be 1,3,5, . . . after receiving each extra consecutive NACK (no acknowledgment from the wireless station 121). This approach utilizes extra time and frequency resources efficiently; however, each extra adjustment will add delay to data delivery.

2.) Latency-efficient approach: In this approach, the wireless station 121 transmits respective data with low latency requirements. Thus, the “Range Expansion” mode supported by the repetition mode is initiated by the maximum applicable repetitions in available bandwidth and remaining TXOP (a.k.a., Transmit Opportunity) duration associated with the wireless station 121 acquiring the corresponding wireless channel via a listen before talk function.

Note that, in certain scenarios such as Trigger-based UL transmission where the STA (wireless station 121) can acquire the knowledge of the received and target SINR from the wireless station 122, the same approach as the one in the AP-driven mode can be applied.

Note further that the criteria to operate in the repetition mode as described herein may include, but is not limited to:

For the wireless station 121 driven case: A configurable number of consecutive acknowledgements (ACK) NOT received by the transmitter (e.g., In UL, if STA or wireless station 121 does not receive X (=2) consecutive ACKs), then the communication management resource 141 and corresponding wireless station 121 initiate execution of the repetition mode of repeatedly transmitting data from the wireless station 121 to the wireless station 122. In other words, as previously discussed, the wireless station 121 can be configured to operate in the repetition mode based on failure of the wireless station 122 to acknowledge prior transmission of wireless messages from the wireless station 121 to the wireless station 122.

For the wireless station 122 driven case: The wireless station 122 and corresponding communication management resource 142 can be configured to announce the minimum required signal-to-noise ratio in the trigger frame transmitted to the wireless station 121. The wireless station 122 corresponding communication management resource 142 also can be configured to notify the wireless station 121 to execute the repetition mode (a.k.a., “Range Expansion” transmission mode) in the corresponding uplink direction from the wireless station 121 to the wireless station 122. This repetition mode can be activated in conjunction with the corresponding resource allocation of wireless resources (such as wireless channel, wireless bandwidth, wireless resource units, etc.) allocated for use by the wireless station 121 to communicate in the uplink direction to the wireless station 122.

Note further that examples as discussed herein can include initiating termination of the repetition mode by either the wireless station 121 or the wireless station 122.

The criteria to stop execution of the repetition mode may include, but is not limited to:

In accordance with the wireless station 121 and corresponding communication management resource 141 controlling implementation of the repetition mode, a value Y such as a configurable number of consecutive acknowledgements (ACK) is communicated from the wireless station 121 or other suitable entity to the wireless station 122 in an uplink direction. If the wireless station 121 receives Y (=2) consecutive ACKs from the wireless station 122, then the wireless station 121 switches from the repetition mode to the normal mode (i.e., non-repetition mode) because it is assumed that the wireless station 122 receives the wireless communications from the wireless station 121 at a sufficiently high power level.

In accordance with the wireless station 122 and corresponding communication management resource 142 controlling implementation of the repetition mode, the wireless station 122 notifies the wireless station 121 and possibly other wireless stations to switch back to the normal mode if the wireless station 122 is able to receive and decode the individual signal replicas without any combining method, which means that repetition is no longer necessary. If the individual instances of the signals transmitted by the wireless station 121 to the wireless station 122 are not discernible to the wireless station 122, then the wireless station 122 does not notify the wireless station 121 to operate in the normal mode.

As shown in FIG. 3, the wireless communication link 127 provides wireless connectivity between the wireless station 121 and the wireless station 122. The wireless station 122 can be configured to receive a repetition settings notification 310 from the wireless station 121 or other suitable entity in the network environment 100. In response to receiving the repetition settings notification 310, the wireless station 122 and corresponding communication management resource 142 switch over to operation in the repetition mode as specified by the repetition settings notification 310.

While in the repetition mode, the wireless station 121 wirelessly transmits corresponding data in an uplink direction or downlink direction to the wireless station 122 and corresponding communication management resource 142. Depending upon the selected repetition mode, and the selected number of repetitions of the same data to be transmitted from the wireless station 121 to the wireless station 122, the wireless station 122 and the corresponding communication management resource 142 configure themselves to receive repetitions of the same data (wireless signals) transmitted from the wireless station 121 in accordance with a format specified by the repetition settings notification 310.

In this example, assume that the wireless station 121 or other suitable entity detects degradation of the wireless communication link 127 and an inability to reliably transmit data over the wireless communication link to the wireless station 122. In such an instance, the wireless station 121 transmits a respective repetition settings notification 310 to the wireless station 122. The repetition settings notification 310 notifies the wireless station 122 corresponding communication management resource 142 of the corresponding format which the wireless station 121 and corresponding communication management resource 141 plans to communicate corresponding subsequent data over the wireless communication link 127 to the wireless station 122.

In response to receiving the corresponding repetition settings notification 310, the wireless station 122 configures itself to receive subsequent repeatedly transmitted data from the wireless station 121 over the wireless communication link 127 to the wireless station 122. In this example, the wireless station 121 and corresponding communication management resource repeatedly transmit the corresponding DATA1 over the wireless communication link 127 multiple times. For example, a wireless station 121 transmits a first instance of the DATA1 in wireless signal 1-1 and a second instance of the DATA1 in wireless signal 1-2.

The wireless station 122 implements the corresponding coherent combining function 325 to analyze the corresponding repeatedly transmitted signals (DATA1) such as signal 1-1 and signal 1-2. In other words, the coherent combining function 325 analyzes the combination of signal 1-1 including DATA1 and the signal 1-2 including DATA1 to reproduce a rendition of the original signal DATA1. In this example, the reproduced rendition of the signal DATA1 based on the combination of signal 1-1 and the signal 1-2 results in a better rendition than either a rendition of the DATA1 from the signal 1-1 or signal 1-2 individually. Accordingly, implementation of the repetition mode increases the ability for the wireless station 122 and corresponding communication management resource 142 to reproduce an exact replica of the signal DATA1 communicated to the wireless station 122.

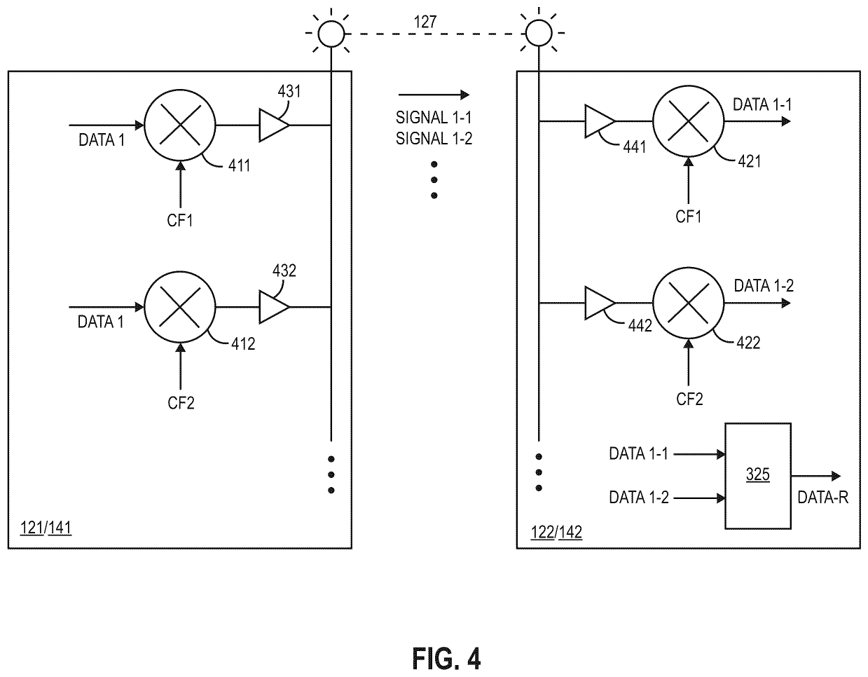

FIG. 4 is an example diagram illustrating implementation of the repetition mode and corresponding coherency analyzer function as discussed herein.

As previously discussed, the wireless station 121, wireless station 122, or other suitable entity detects the need for the wireless station 121 to transmit in the repetition mode to increase the likelihood that the corresponding wireless station 122 is going to properly receive the transmitted DATA1.

In one example, assume that the wireless station 121 is allocated use of bandwidth such as including multiple carrier frequencies CF1 and CF2 to transmit the corresponding DATA1 over the wireless communication link 127 to the wireless station 122. The multiplier 411 (such as mixer) receives the input signal such as DATA1 (such as a modulated data signal capturing a string of data bits) as well as receives the carrier frequency CF1. Based on a combination of received signal DATA1 and the carrier frequency CF1, the multiplier 411 produces an output fed to the corresponding antenna driver circuitry 431. Based on the signal outputted from the multiplier 411, the antenna driver circuitry 431 causes the antenna hardware of the wireless station 121 to produce the wireless signal 1-1 transmitted over the wireless communication link 127.

The multiplier 412 (such as mixer) receives the input signal such as DATA1 (such as a modulated data signal) as well as receives the carrier frequency CF2. Based on a combination of received signal DATA1 and the carrier frequency CF2, the multiplier 412 produces an output fed to the corresponding antenna driver circuitry 432. The antenna driver circuitry 432 causes the antenna hardware of the wireless station 121 to produce the wireless signal 1-2 transmitted over the wireless communication link 127.

Note that the wireless signal 1-1 and the wireless signal 102 can be transmitted in the same time duration or different time durations.

The corresponding antenna hardware of the wireless station 122 receives both the wireless signal 1-1 and the wireless signal 1-2. The combination of the antenna hardware of the wireless station 122 and the antenna receiver circuitry 441 convert the received wireless signal 1-1 into a signal supplied to the multiplier 421. In addition to receiving the signal outputted from the antenna receiver circuitry 441, the multiplier 421 also receives the carrier frequency CF1. Via the multiplier 421, the wireless station 122 removes the carrier frequency CF1 from the received wireless signal 1-1 to produce the corresponding signal DATA1-1 (such as a first rendition of the original signal DATA1).

As further shown, the combination of the antenna hardware of the wireless station 122 and the antenna receiver circuitry 442 convert the received wireless signal 1-2 into a signal supplied to the multiplier 442. In addition to receiving the signal outputted from the antenna receiver circuitry 442, the multiplier 422 also receives the carrier frequency CF2. Via the multiplier 422, the wireless station 122 removes the carrier frequency CF2 from the received wireless signal 1-2 to produce the corresponding signal DATA1-2 (such as a second rendition of the original signal DATA1).

As previously discussed, the wireless station 122 and/or communication management resource 142 includes a coherent combining function 325 to analyze in the combined the corresponding received signals DATA1-1 and DATA1-2 to produce a rendition of the signal DATA1. Based on the combination of generated signal DATA1-1 and the generated signal DATA1-2, the coherent combining function 325 produces the corresponding reproduced signal DATA-R. Based on the combining provided by the coherent combining function 325, the reproduced signal DATA-R is a better reproduction of the original signal DATA1 than either of the signal DATA1-1 or the signal DATA1-2 individually.

Accordingly, examples herein include a new mode (a.k.a., repetition mode) of operation which employs the concept of signal repetition across the following different types of domains to increase SNR of wireless signal received at the corresponding wireless station 122. As previously discussed, the receiver wireless station 122 employs a coherent combining function (a.k.a., coherent combining function 325) in the time domain or the frequency domain based on the received repetitive signals DATA1-1 and DATA1-2 received by the wireless station 122 and corresponding communication management resource 142 resulting in overall SNR improvements at the wireless station 122 receiving the corresponding signals from the wireless station 121.

The repetition mode can be implemented in any of one or more domains such as frequency domain, spatial domain, time domain, across multiple links (assuming 802.11be MLO support), etc.

The selected domain in which the corresponding repetition of the signal is implemented can be indicated such as via the repetition settings notification 310 in any suitable manner such as via communications over the PHY, MAC layer of 802.11.

Note that a combination of above-mentioned domains can be simultaneously implemented.

In accordance with further examples, notification of the repetition mode capability associated with the wireless station 121 or wireless station 122 can occur during a communication exchange between the wireless station 121 and the wireless station 122 at the beginning of or after establishing the corresponding wireless vacation link 127. The notification of the capability can occur at any suitable time such as at the time of association of the wireless station 121 with the wireless station 122.

Note further that this disclosure includes example parameters in which to determine the start and stop times of executing the repetition mode. For example, certain environmental conditions may cause the wireless stations to operate in the repetition mode. When the environmental multiple conditions become more favorable, during which the wireless communication link provides good performance, the wireless stations can switch back to the normal operating mode of not implement the repeating mode.

As discussed herein, the repetition mode offers a straightforward and effective approach to extending wireless transmission range of the wireless station 121 resulting in increased SNR at the wireless station 122 receiver.

### Leveraging Signal Repetition for Range Expansion:

As previously discussed, the repetition mode includes the deliberate transmission of identical or slightly modified copies of the same signal across the wireless medium such as wireless communication link 127. The goal of the repetition mode is to counteract the adverse impact of channel impairments or degradation—such as due to path loss, fading, noise, and interference—that often curtail the coverage distance and reliability of wireless links.

### Utilizing Maximum Ratio Combining (MRC):

As previously discussed, the coherent combining function 325 can be configured to implement Maximum Ratio Combining in the time domain, frequency domain, etc. In one example, the MRC implemented by the coherent combining function 325 is a coherent combining method that yields the maximum possible SNR gain at the wireless station 122 receiving the respective wireless signals 1-1 and 1-2. When the AP (such as wireless station 122) employs MRC as the coherent combining technique and N independent signal replicas are dispatched through the channel, the resultant increase in received SNR in dB can be approximated by 10*log (N).

For example, transmitting two signal replicas (such as signal 1-1 and signal 1-2) in the UL could yield an anticipated 3 dB enhancement in received SNR. As another example, the receiver wireless station 122 may experience a 9.53 dB gain in SNR when N=9, i.e., replicating the original signal over 8 other branches including the original branch.

The proposed means to designate RUs (a.k.a., Resource Units) which are to carry repeated data for various allowed 802.11 channel bandwidths (e.g. 20 Mhz, 40 MHz, 80 MHz etc). The RUs to be repeated are to be indicated via a set of RU Ids (already employed in present-day 802.11ax onwards).

Note that a Resource Unit (RU) is a unit in OFDMA (Orthogonal Frequency Division Multiple Access) terminology used in 802.11ax WLAN to denote a group of 78.125 kHz bandwidth subcarriers (tones) used in both DownLink (DL) or UpLink (UL) transmissions. With OFDMA, different transmit powers may be applied to different RUs.

As previously discussed, during association of establishing corresponding wireless communication link 127, the wireless station 121 and the wireless station 122 can be configured to negotiate which repetition domains are to be supported for this association.

There are multiple possible implementations of implementing the repetition mode of extending wireless coverage including AP driven solution and a STA driven solution.

In the AP driven mode, the AP such as wireless station 122 indicates when and where repeated data is expected for all STAs. The receiving STAs comply with the command to operate in the repetition mode.

In the AP-driven and STA assisted mode, the AP indicates when and where repeated information is expected for all STAs. However, only STAs (a.k.a., wireless stations) in the network environment 100 whose transmissions can't meet target RSSI (in Control Info of TRS in e.g. HE PPDU) chose to employ repetition. If desired, each wireless STA can be configured to indicate the unmet target condition via an additional information in its header information (e.g. UHR SIG-new IE).

In a STA-driven mode, the AP (wireless station 122) has no apriori know-how of time and duration over which repetition information is to be employed by a given STA (wireless station 121). Each wireless station STA (such as including wireless station 121) in the network environment can be configured to indicate a selected repetition mode via additional information in its header information (e.g., UHR SIG-new IE) communicated to the wireless station 122.

In one example, the wireless station 121 communicates information regarding a selected repetition mode in a data packet such as a UHR SIG will logically comprise of the following three sections such as: i) first information indicating target resource units for repetition and a corresponding repetition pattern, ii) time domain repetition related fields, and iii) Link domain repetition related fields.

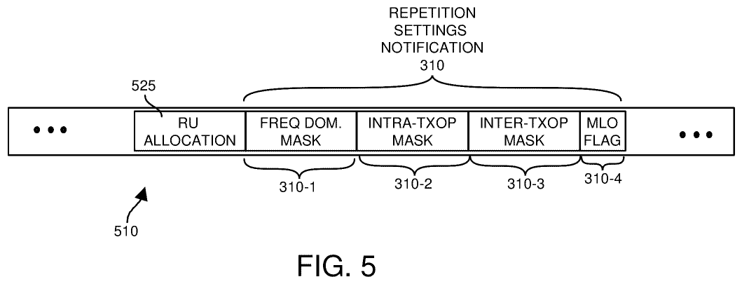

FIG. 5 is an example diagram illustrating configuration information included in a repetition settings notification as discussed herein.

In this example, the repetition settings notification 310 is included in a respective message communicated from a transmitter to a receiver in the network environment 100. Assume in this example that the wireless station 121 communicates the message 510 (such as a modified UHR SIG) over the wireless communication link 127 to the wireless station 122 to control operation in the repetition mode.

As previously discussed, via the repetition settings notification 310, the transmitter such as a wireless station 121 and corresponding communication management resource 141 notify the receiver wireless station 122 about the repetition format that the wireless station 121 and corresponding communication management resource 141 are going to employ to communicate repetitions of the same data over the wireless communication link 127 to the wireless station 122 corresponding communication management resource 142. Further, as previously discussed, the wireless station 122 and corresponding communication management resource 142 implement a respective coherent combining function 325 through reproduce a respective repeated signal.

The transmitter such as the wireless station 121 can be configured to inform the receiver such as wireless station 122 about the repetition scheme (a.k.a. format) it is employing to enable coherent combining via a respective coherent combining function 325 at the wireless station 122 and/or corresponding communication management resource 142 upon the reception of signal replicas.

In one example, the coherent combining function 325 implements so-called MRC (Maximum Ratio Combining), which is a coherent combining method that yields a maximum possible SNR gain for the received signal that is replicated. When the wireless station 122 and corresponding communication management resource 142 employ MRC as the coherent combining technique and N independent signal replicas are wirelessly received over the wireless communication link, the resultant increase in received SNR in dB (decibel) can be approximated by 10*log (N).

As in the illustrative example of FIG. 4 of transmitting two signal replicas of DATA1 in the uplink over the wireless communication link 127 from the wireless station 121 to the wireless station 122, the repetition mode may yield an anticipated 3 dB enhancement in received SNR by the wireless station 122.

As another example, the wireless station 122 can observe 9.53 dB gain in SNR when N=9, i.e., replicating the original signal over 8 other branches. Thus, in a normal mode, a single branch supports communication of data over the wireless communication link to the wireless station 122. Any number of additional branches can be used to support operation of the wireless stations in the repetition mode.

Further examples herein include implementation of a so-called new “Range Expansion” Field (repetition setting notification 310) such as included in a U-SIG message right after or along with “RU Allocation” information 525 indicating what resource units have been allocated for use by the wireless station 121 to communicate over the wireless communication link 127 to the wireless station 122.

In this example, the repetition settings notification 310 (such as new Repetition Data Field) carries necessary information about the time/freq/link domain repetition information as implemented by the wireless station 121 to communicate the data such as signal DATA1 to the wireless station 122. The repetition settings notification 310 further indicates a corresponding repetition format which the wireless station 121 is going to transmit the signal DATA1 over the wireless communication link 127 to the wireless station 122. The wireless station 122 implements a corresponding repetition format as specified by the repetition settings notification 310 to receive the repeated instances of the signal DATA1 transmitted from the wireless station 121.

In this example, the repetition settings notification 310 such as “Repetition Field” includes multiple subfields (data fields). For example, the data field 310-1 (such as Freq.-domain Mask of 4 bits) includes information about the repetition scheme over RUs 525 for repetition in the frequency domain. The data field 310-2 and data field 310-3 (such as Time-domain Mask of 1 octet) includes repetition mode information about inter and intra TXOP repetition schemes. The data field 310-4 (such as MLO or MultiLink option Activation of 1 bit) is a flag that enables repetition over multiple links in MLO-capable device

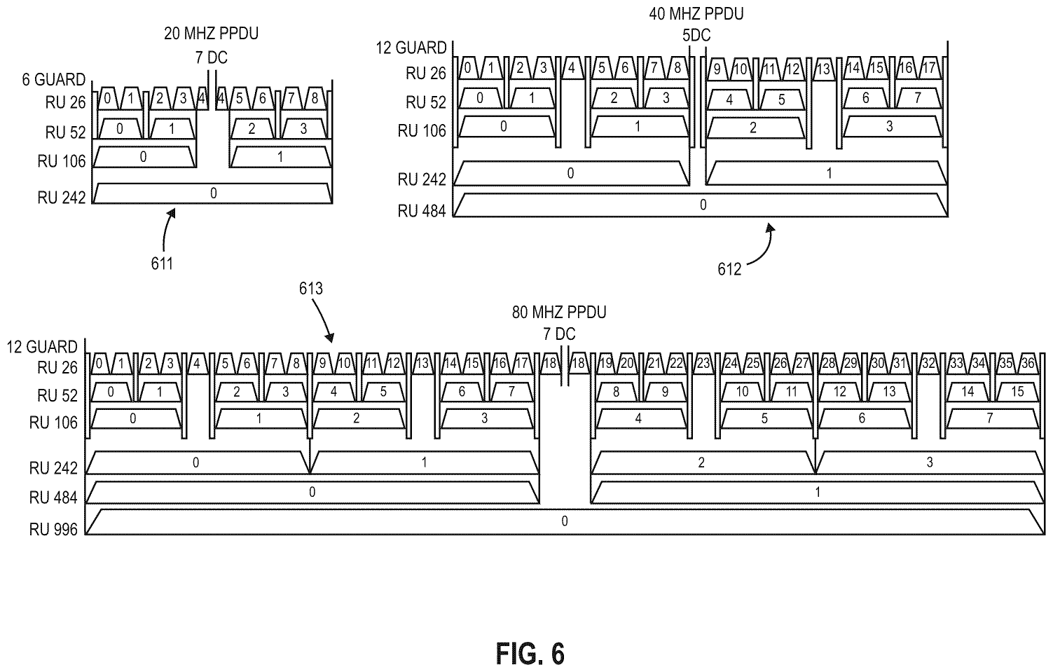

FIG. 6 is an example diagram illustrating different possible partitioning applied to an acquired wireless channel as discussed herein.

In accordance with further examples as discussed herein, each of the wireless station 121 and the wireless station 122 is configured to implement a respective listen before talk function to acquire a corresponding wireless channel in which to communicate data over the wireless communication link 127.

Note that the size of the acquired wireless channel and corresponding partitioning may vary. For example, as shown in FIG. 6, a 20 megahertz channel, a 40 megahertz channel, in 80 megahertz channels, etc., may be allocated for use by the wireless station 121 to communicate over the wireless communication link 127 to the wireless station 122.

As shown in partition 611 of a corresponding acquired 20 megahertz wireless channel, the allocated wireless channel can be subdivided into any suitable number of resource units or subcarrier tones such as a single set of subcarrier frequency or tones (0) such as 242 tones, two sets of subcarrier frequencies or tones (0, 1) each set including 106, four sets of subcarrier frequencies or tones (0, 1, 2, 3) each set including 52, or eight sets of subcarrier frequencies or tones (0, 1, 2, 3, 4, 5, 6, 7, 8) each set including 26.

As shown in partition 612 of a corresponding acquired 40 megahertz wireless channel, the allocated wireless channel can be subdivided into any suitable number of resource units or subcarrier tones such as a single set of subcarrier frequency or tones (0) such as 484 tones, two sets of subcarrier frequencies or tones (0, 1) each set including 242, four sets of subcarrier frequencies or tones (0, 1, 2, 3) each set including 108, eight sets of subcarrier frequencies or tones (0, 1, 2, 3, 4, 5, 6, 7) each set including 52, or sixteen sets of subcarrier frequencies or tones (0, 1, 2, 3, 4, 5, 6, 7, 8, . . . , 15) each set including 26.

As shown in partition 613 of a corresponding acquired 80 megahertz wireless channel, the allocated wireless channel can be subdivided into any suitable number of resource units or subcarrier tones such as a single set of subcarrier frequency or tones (0) such as 996 tones, two sets of subcarrier frequencies or tones (0, 1) each set including 484, four sets of subcarrier frequencies or tones (0, 1, 2, 3) each set including 242, eight sets of subcarrier frequencies or tones (0, 1, 2, 3, 4, 5, 6, 7, 8) each set including 106, sixteen sets of subcarrier frequencies or tones (0, 1, 2, 3, 4, 5, 6, 7, 8, . . . , 15) each set including 52, or thirty two sets of subcarrier frequencies or tones (0, 1, 2, 3, 4, 5, 6, 7, 8, . . . , 32) each set including 26.

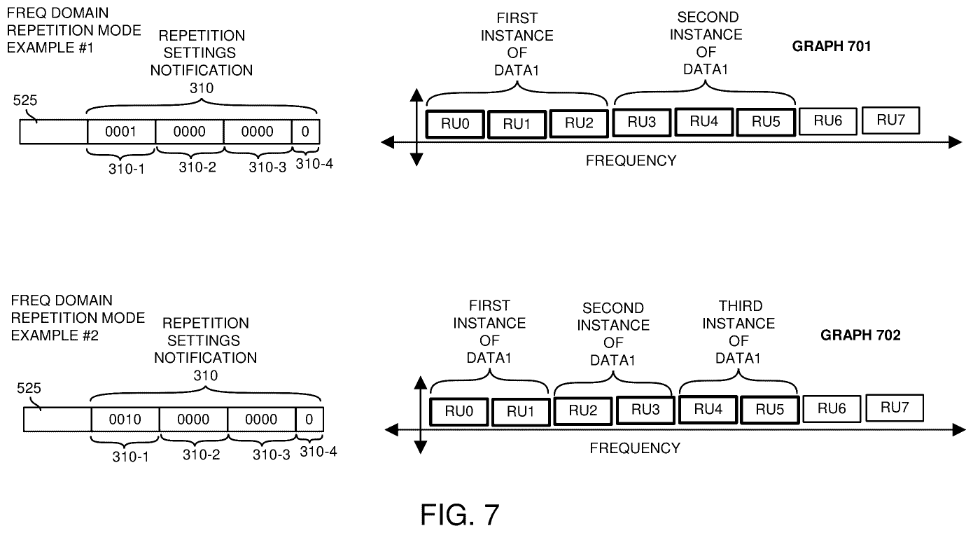

FIG. 7 is an example diagram illustrating operation of wireless system and corresponding wireless stations in a frequency domain repetition mode as discussed herein.

### Base Assumptions:

Consecutive RU treatment
Duplication may happens in RUs following original data in an RU multiple bit value to indicate the desired duplication
Assume that the wireless station 121 acquires and 80 megahertz channel to communicate data in the repetition mode to the wireless station 122.
Example: 80 MHz RU106 RU{0, 1, 2, 3, 4, 5, 6, 7}
0001=duplicate once {0, 1, 2} {3, 4, 5}
0010=duplicate twice {0, 1} {2, 3} and {4, 5}
0011=duplicate thrice {0} {1, 2, 3}
0100=duplicate 4 times {0} {1, 2, 3, 4}
0110=duplicate 6 times {0} {1, 2, 3, 4, 5, 6}

In the example #1 of FIG. 7, via the frequency repetition mode, assume that the data field 525 communicated to the wireless station 122 indicates allocation of resource units (80 MHz RU106 {0, 1, 2, 3, 4, 5, 6, 7}) as well as data field 310-1 of the repetition settings notification 310 being set to the value of 0001. The data field 310-2, 310-3, 310-4 are set to 0.

Accordingly, in this example #1 the setting of the data field 310-1 and communication of the repetition settings notification 310 to the wireless station 122 indicates that the wireless station 121 plans to subsequently operate in a frequency domain repetition mode of duplicating the respective data DATA1 communicated from the wireless station 121 to the wireless station 122. In this example, assume that the allocated wireless channel of 80 megahertz is split into 8 portions (partitions, resource units,) 0, 1, 2, 3, 4, 5, 6, 7. Recall that each of the resource units includes one or more subcarrier frequencies in which to transmit a corresponding data over the wireless communication link 127.

In such an instance, after transmitting the message 510 (see FIG. 5) to the wireless station 122 indicating the repetition setting notification 310, in accordance with the transmitted repetition setting notification 310, the wireless station 121 subsequently transmits a first instance of data (such as DATA1 via signal 1-1) across or over resource units RU0, RU1, RU2 (3 sets of allocated subcarrier frequencies). Because the wireless station 121 operates in single repetition mode, the wireless station 121 also transmits a second instance of data (such as DATA1 via signal 1-2) across or over resource units RU3, RU4, RU5 (3 sets of subcarrier frequencies). In a manner as previously discussed, the wireless station 122 receives the corresponding wireless signal 1-1 (via resource units RU0, RU1, RU2) and signal 1-2 (via resource units RU3, RU4, RU5). The coherency combined function 325 produces DATA1-R via the received instances of the DATA1 received via wireless signal 1-1 wireless signal 1-2, the rendition DATA1 being a better rendition of DATA1.

In example #2 (bottom of FIG. 7) of implementing frequency domain repetition, assume that the repetition notification settings 310 indicate allocation of resource units (80 MHz RU106 {0, 1, 2, 3, 4, 5, 6, 7}) as well as data field 310-1 is set to the binary value of 0010 (2 extra repetitions of the DATA1). The data field 310-2, 310-3, 310-4 are set to 0. Accordingly, in this example, the setting of the data field 310-1 (time domain repetition field) indicates that the wireless station 121 plans to subsequently operate in a frequency domain repetition mode of duplicating the respective data communicated to the wireless station 122. In this example, the allocated wireless channel of 80 megahertz is split into 8 portions (partitions) 0, 1, 2, 3, 4, 5, 6, 7.

In such an instance, in accordance with the previously transmitted repetition settings notification 310 associated with example #2, the wireless station 121 transmits a first instance of data (such as DATA1) across or over resource units RU0, RU1 (two sets of subcarrier frequencies). Because the wireless station 121 operates in a multiple repetition mode, the wireless station 121 also transmits a second instance of data (such as DATA1) across or over resource units RU2, RU3 (two sets of subcarrier frequencies). The wireless station 121 also transmits a third instance of data (such as DATA1) across or over resource units RU3, RU4 (two sets of subcarrier frequencies). In a similar manner as previously discussed, the wireless station 122 and corresponding coherent combining function 325 receive the corresponding wireless signals associated with the 3 instances of transmitted data DATA1 and produces DATA1-R, which is a better rendition of DATA1 than any of the received instances of DATA1 individually.

Note: Depending on the channel bandwidth and the number of assigned RUs, the Freq. Domain masks allows for up to 14 repetitions (i.e., 1111) in which a first RU can be replicated over the next 15 available RUs. For instance, such a scenario is feasible in 40 MHz channel with 26-tones RUs allocated to a user. Alternatively, an 80 MHz channel can support up to 15 repetitions over RUs of size 52 tones.

Accordingly, implementation of the frequency repetition mode includes repeating transmission of the data DATA1 from the first wireless station 121 over the wireless communication link 127 in the frequency domain. For example, via the first wireless carrier frequency CF1 such as one or more tones, the wireless station 121 transmits a first instance of the data DATA1 over the wireless communication link from the first wireless station to the second wireless station 122; via a second wireless carrier frequency CF2 different than the first wireless carrier frequency CF1, the wireless station 121 transmits a second instance of the data DATA1 over the wireless communication link 127 from the first wireless station 121 to the second wireless station 122.

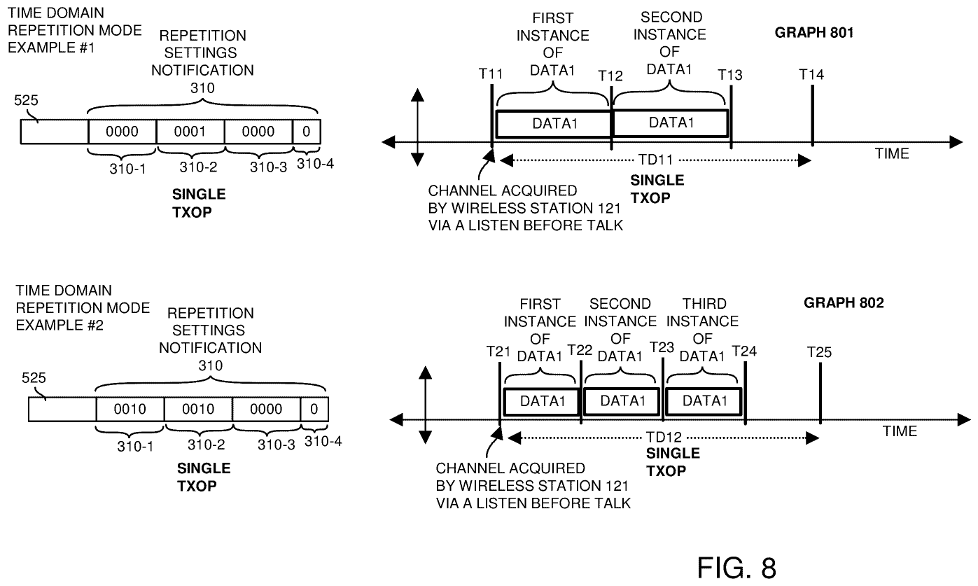

FIG. 8 is an example diagram illustrating operation of a wireless system in a first time domain repetition mode as discussed herein.

In this example, the repetition settings notification 310 includes data field 310-2 and data field 310-3 to control operation of the wireless station 121 and the wireless station 122 in the time domain repetition mode.

Note that the data field 310-4 is set to 0 in this case. Setting of this data field 310-4 and corresponding bit to 0 indicates that the time domain repetition mode is not to be implemented in a multi-link circumstance. For example, the wireless station 121 may be in wireless communication with the wireless station 122 over multiple different wireless communication links such as wireless communication link 127 as well as another wireless communication link. The wireless communication link 127 may support wireless communications in accordance with a first wireless communication protocol (2.4 gigahertz) as well as a second wireless communication link using a second wireless communication protocol (5 gigahertz). In such a circumstance, when the data field 310-4 is set to a logic one, this indicates to operate the wireless stations in the repetition mode over each of the corresponding wireless communication links (multi-links) between the wireless station 121 and the wireless station 122.

As further shown, the repetition settings notification 310 includes two subfields corresponding to intra-TXOP (data field 310-2) and inter-TXOP (data field 310-3) repetitions, respectively. Note again that the term TXOP represents a duration of time in which the corresponding wireless station 121 acquires a channel via listen before talk in response to detecting that monitoring of the wireless channel of interest is lower than the corresponding threshold level for a predetermined amount of time.

Further in this example, assume that the Intra-TXOP subfield (such as data field 310-2) represents or occurs across consecutive OFDMA symbols within a single TXOP. Additionally, assume that the Inter-TXOP subfield (such as data field 310-3) represents or occurs over multiple TXOPs such as consecutive TXOPs.

### EXAMPLES

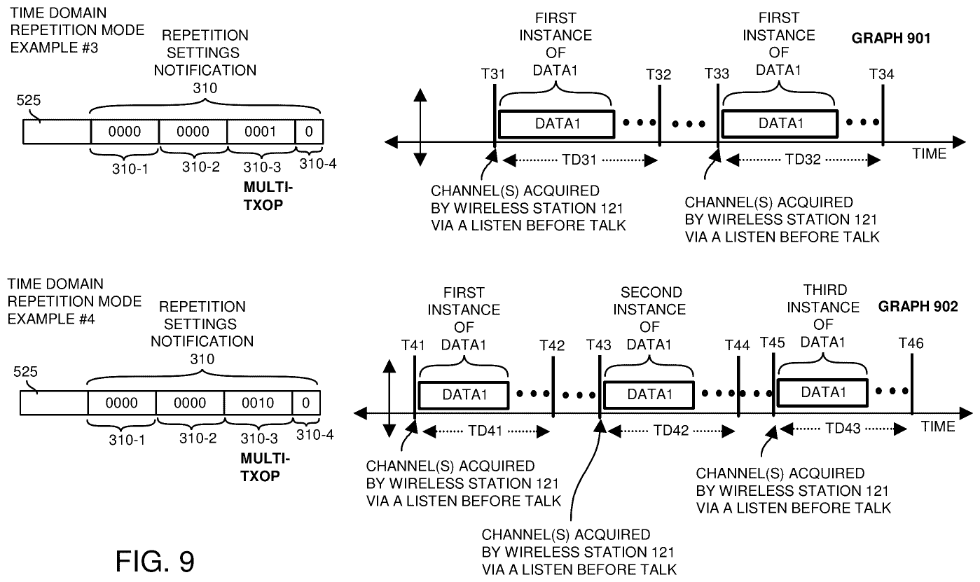

If the data field 310-2=0000 and the data field 310-3=0000, then there is no time domain repetition.
If the data field 310-2=0011 and the data field 310-3=0000, then the wireless station 121 repeats the corresponding data DATA1 (such as a string of bits encoded as symbols) three times during a same TXOP (see examples in FIG. 8).
If the data field 310-2=0000 and the data field 310-3=0001, then the wireless station 121 repeats the corresponding data DATA1 two times over multiple TXOPs (see examples in FIG. 9).

More specifically, as shown in FIG. 8, assume that the wireless station 121 or other suitable entity selects the time domain repetition mode (single TXOP mode) as in example #1 (top of FIG. 8) in which the corresponding data field 310-2 is set to 0001. In such an instance, the wireless station 121 or other suitable entity notifies the wireless station 122 of the repetition settings notification 310 indicating that repetition will occur within a single channel acquisition (single TXOP).

As shown in graph 801, the wireless station 121 acquires the corresponding one or more bandwidth resources (such as resource units, channels, bandwidth, etc.) at or around time T11. As previously discussed, this includes the wireless station 121 detecting that the amount of wireless energy in the allocated bandwidth is below a threshold level and the wireless station 121 is able to communicate in that time duration TD11. In response to the channel acquisition for time duration TD11, and in accordance with the corresponding repetition settings notification 310 provided to the wireless station 122 such as at the beginning of the acquired time duration TD11 or other suitable time prior to time T11, the wireless station 121 subsequently transmits (in the time domain) the first instance of the DATA1 between time T11 and time T12; the wireless station 121 subsequently transmits the second instance of the DATA1 between time T12 and time T13.

Accordingly, time domain repetition includes repeating transmission of the data DATA1 over the wireless communication link 127 in the time domain. The repeated transmission of the data DATA1 in the time domain in this example #1 includes: in a first time duration between T11 and T12, transmitting a first instance of the data DATA1 over the wireless communication link from the first wireless station to the second wireless station; and in a second time duration between T12 and T13 following the first time duration, transmitting a second instance of the data DATA1 over the wireless communication link 127 from the first wireless station 121 to the second wireless station 122. As previously discussed, the second instance of the data DATA1 is a replica of the first instance of the data DATA1.

As shown in graph 801, the first instance of the data DATA1 is transmitted over a first allocated wireless bandwidth; the second instance of the data DATA1 is transmitted over the first wireless bandwidth; and the first time duration (T11 to T12) and the second time duration (T12 to T13) both reside within a single acquisition (time duration TD11) of the acquired wireless bandwidth or channel by the first wireless station 121.

In the example #1 associated with graph 801, the repetition settings notification 310 specifies how many instances (such as one extra instance) in which data DATA1 is scheduled to be repeatedly transmitted from the first wireless station 121 to the second wireless station 122 via the repetition mode. As previously discussed, the data field 310-2 (bit value of 0001) of the repetition settings notification 310 indicates that the first wireless station 121 is configured to repeat transmission (such as signal 1-1 and signal 1-2 at the same carrier frequency) of the data DATA1 in a single TXOP (Transmit Opportunity) such as time duration TD11 acquired by the first wireless station. Accordingly, via the repetition settings notification 310, the wireless station 122 is notified of the corresponding format in which to receive the repetition of data transmitted from the wireless station 121 during the time duration TD11.

As further shown in example #2 in FIG. 8, assume that the wireless station 121 or other suitable entity selects the time domain repetition mode (single TXOP mode) in which the corresponding data field 310-2 is set to 0010. The MultiLink option associated with data field 310-4 is set to 0. In such an instance, the wireless station 121 or other suitable entity notifies the wireless station 122 of the repetition settings notification 310 indicating that repetition will occur within a single channel acquisition (single TXOP such as time duration TD12) with 2 extra instances of the data DATA1.

More specifically, as shown in graph 802, the wireless station 121 acquires the corresponding one or more bandwidth resources (such as resource units, channels, bandwidth, etc.) at or around time T21. In response to the channel acquisition for time duration TD12, and in accordance with the corresponding repetition settings notification 310 provided from the wireless station 121 to the wireless station 122 such as at the beginning of the acquired time duration TD12 or sometime well prior to time T21, the wireless station 121 subsequently transmits the first instance of the DATA1 between time T21 and time T22; the wireless station 121 subsequently transmits the second instance of the DATA1 between time T22 and time T23; the wireless station 121 subsequently transmits the third instance of the DATA1 between time T23 and time T24. Accordingly, time domain repetition includes repeating transmission of the data DATA1 over the wireless communication link 127 in the time domain over the allocated wireless bandwidth.

As previously discussed, the second instance of the data DATA1 is a replica of the first instance of the data DATA1. The third instance of the data DATA1 is a replica of the first instance of the data DATA1. As shown in graph 802, the first instance of the data DATA1 is transmitted over a first allocated wireless bandwidth; the second instance of the data DATA1 is transmitted over the first wireless bandwidth; the third instance of the data DATA1 is transmitted over the first allocated wireless bandwidth. As previously discussed, the first wireless bandwidth allocated to the wireless station 121 can be specified by the data field 525.

Notably, in this example, the first time duration (T21 to T22) and the second time duration (T22 to T23) and the third time duration (T23 to T24) reside within a single acquisition time duration TD12 (such as single TXOP defined by start time T21 and end time T25) of the wireless bandwidth by the first wireless station 121.

In the example #2 associated with graph 802, as previously discussed, the repetition settings notification 310 communicated to the wireless station 122 specifies how many instances (such as two extra instances) in which data DATA1 is scheduled to be repeatedly transmitted from the first wireless station 121 to the second wireless station 122 via the repetition mode. As previously discussed, the data field 310-2 (bit value of 0010) of the repetition settings notification 310 indicates that the first wireless station 121 is configured to repeat transmission of the data DATA1 multiple times in a single TXOP (Transmit Opportunity such as time duration TD12) acquired by the first wireless station.

FIG. 9 is an example diagram illustrating operation of a wireless system in a second time domain repetition mode as discussed herein.

As shown in FIG. 9, assume that the wireless station 121 or other suitable entity selects the time domain repetition mode (multi-TXOP mode) as in example #3 (top of FIG. 9) in which the corresponding data field 310-3 is set to 0001. The other data fields associated with the repetition settings notification 310 are set to 0. In such an instance, the wireless station 121 or other suitable entity notifies the wireless station 122 of the repetition settings notification 310 indicating that repetition will occur within a multi-channel acquisition (multiple different TXOPs).

More specifically, as shown in graph 901, the wireless station 121 acquires the corresponding one or more bandwidth resources (such as resource units, channels, bandwidth, etc.) at or around time T31. In response to the channel acquisition for time duration TD31, and in accordance with the corresponding repetition settings notification 310 provided to the wireless station 122 such as at the beginning of the acquired time duration TD31 or other suitable time prior to time T31, the wireless station 121 subsequently transmits the first instance of the DATA1 between time T31 and time T32 to the wireless station 122; the wireless station 121 subsequently transmits the second instance of the DATA1 between time T33 and time T34 to the wireless station 122. Accordingly, time domain repetition includes repeating transmission of the data DATA1 over the wireless communication link 127 in the time domain.

The repeated transmission of the data DATA1 in the time domain includes: in a first time duration (first TXOP such as time duration TD31) between T31 and T32, transmitting a first instance of the data DATA1 over the wireless communication link from the first wireless station to the second wireless station; and in a second time duration (second TXOP such as time duration TD32) between T33 and T34 following the first time duration, transmitting a second instance of the data DATA1 over the wireless communication link 127 from the first wireless station to the second wireless station. As previously discussed, the second instance of the data DATA1 is a replica of the first instance of the data DATA1.

In the example #3 associated with graph 901, the repetition settings notification 310 specifies how many instances (such as one extra instance) in which data DATA1 is scheduled to be repeatedly transmitted from the first wireless station 121 to the second wireless station 122 via the repetition mode. As previously discussed, the data field 310-3 (bit value of 0001) of the repetition settings notification 310 indicates that the first wireless station 121 is configured to repeat transmission of the data DATA1 in multiple TXOPs (Transmit Opportunity) such as time duration TD31 and subsequent time duration TD32 acquired by the first wireless station.

As shown in graph 902 FIG. 9, the wireless station 121 acquires the corresponding one or more bandwidth resources (such as resource units, channels, bandwidth, etc.) at or around time T41. In response to the channel acquisition for time duration TD41, and in accordance with the corresponding repetition settings notification 310 provided to the wireless station 122 such as at the beginning of the acquired time duration TD41 or other appropriate time prior to time T41, the wireless station 121 subsequently transmits the first instance of the DATA1 between time T41 and time T42 in time duration TD41; the wireless station 121 subsequently transmits the second instance of the DATA1 in time duration TD42 between time T43 and time T44; the wireless station 121 subsequently transmits the third instance of the DATA1 in time duration TD43 between time T45 and time T46. Accordingly, time domain repetition includes repeating transmission of the data DATA1 over the wireless communication link 127 in the time domain.

In the example #4 associated with graph 902, the repetition settings notification 310 specifies how many instances (such as one extra instance) in which data DATA1 is scheduled to be repeatedly transmitted from the first wireless station 121 to the second wireless station 122 via the repetition mode. As previously discussed, the data field 310-3 (bit value of 0010 of the repetition settings notification 310 indicates that the first wireless station 121 is configured to repeat transmission of the data DATA1 in three TXOPs (Transmit Opportunity) such as in each time duration TD41, time duration TD42, and time duration TD43 acquired by the first wireless station.

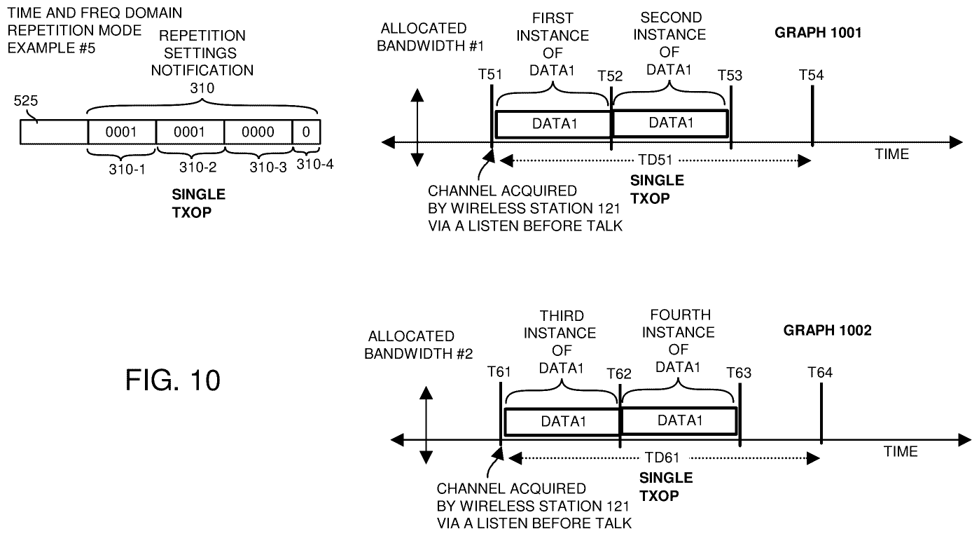

FIG. 10 is an example diagram illustrating operation of a wireless system in a combination time domain and frequency domain repetition mode as discussed herein.

As shown in FIG. 10, assume that the wireless station 121 or other suitable entity selects a combination time/frequency domain repetition mode (single TXOP mode) as in example #5 in which the data field 310-1 is set to 0001 and data field 310-2 is set to 0001. In such an instance, the wireless station 121 or other suitable entity notifies the wireless station 122 of the repetition settings notification 310 indicating that repetition will occur within a single acquisition (a first TXOP) associated with a first allocated bandwidth #1 and a single acquisition (the second TXOP) associated with a second allocated bandwidth #2.

As shown in graph 1001, the wireless station 121 acquires the corresponding one or more bandwidth resources (such as resource units, channels, bandwidth, etc.) associated with the allocated bandwidth #1 as specified by the data field 525 at or around time T51. In response to the channel acquisition for time duration TD51, and in accordance with the corresponding repetition settings notification 310 provided to the wireless station 122 such as at the beginning of the acquired time duration TD51 or other suitable time prior to time T51, the wireless station 121 subsequently transmits the first instance of the DATA1 between time T51 and time T52 over the allocated bandwidth #1; the wireless station 121 subsequently transmits the second instance of the DATA1 between time T52 and time T53 over the allocated bandwidth #1 (using a single TXOP). Accordingly, time domain repetition includes repeating transmission of the data DATA1 over the wireless communication link 127 in the time domain for the first allocated bandwidth #1.

As shown in graph 1002, the wireless station 121 acquires the corresponding one or more bandwidth resources (such as resource units, channels, bandwidth, etc.) associated with the allocated bandwidth #2 as specified by the data field 525 at or around time T61. In response to the channel acquisition (allocated bandwidth #2) for time duration TD61, and in accordance with the corresponding repetition settings notification 310 provided to the wireless station 122 such as at the beginning of the acquired time duration TD61 or other suitable time prior to time T61, the wireless station 121 subsequently transmits the first instance of the DATA1 between time T61 and time T62 over the allocated bandwidth #2; the wireless station 121 subsequently transmits the second instance of the DATA1 between time T62 and time T63 over the allocated bandwidth #2. Accordingly, time domain repetition includes repeating transmission of the data DATA1 over the wireless communication link 127 in the time domain for the second allocated bandwidth #2.

In such an instance, the coherency combine function 325 combines the 4 instances of receiving DATA1 to produce a respective rendition of the original DATA1.

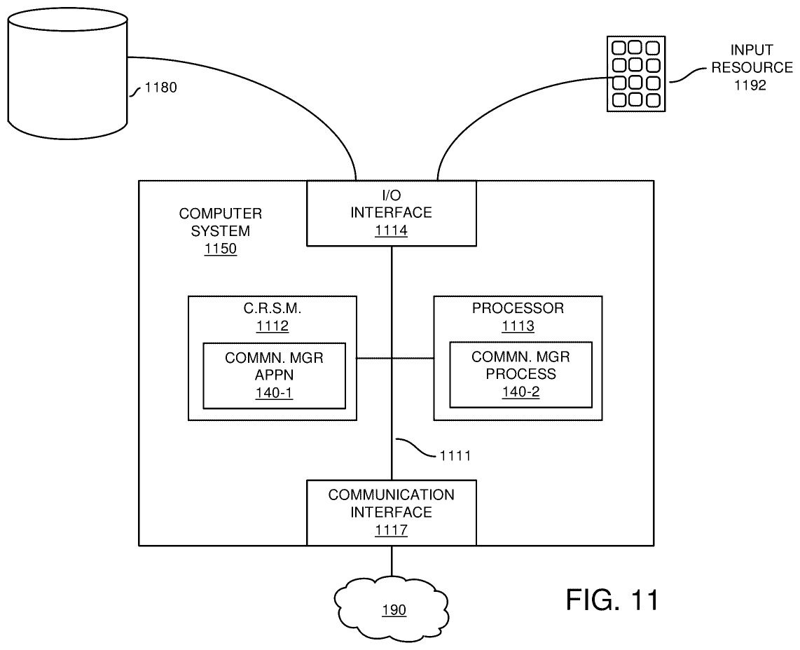

FIG. 11 is an example block diagram of a computer system for implementing any of the operations as previously discussed according to examples herein.

Any of the resources (such as wireless stations, communication management resource 141, wireless station 121, communication management resource 142, wireless station 122, etc.) as discussed herein can be configured to include computer processor hardware and/or corresponding executable instructions to carry out the different operations as discussed herein via computer system 1150.

As shown, computer system 1150 of the present example includes an interconnect 1111 coupling computer readable storage media 1112 such as a non-transitory type of media (or more generally, computer readable hardware which can be any suitable type of hardware storage medium in which digital information can be stored and retrieved), a processor 1113 (computer processor hardware), I/O interface 1114, and a communications interface 1117.

I/O interface(s) 1114 supports connectivity to repository 1180 and input resource 1192.

Computer readable storage medium 1112 (such as computer readable hardware or other suitable entity) can be any hardware storage device such as memory, optical storage, hard drive, floppy disk, etc. In one example, the computer readable storage medium 1112 stores instructions and/or data.

As shown, computer readable storage media 1112 can be encoded with management application 140-1 (e.g., including instructions) to carry out any of the operations as discussed herein. The communication manager application 140-1 can be configured to implement any of the operations associated with the wireless station 121, wireless station 122, communication management resource 141, communication management resource 142, etc.

During operation of one example, processor 1113 accesses computer readable storage media 1112 (such as computer readable storage hardware) via the use of interconnect 1111 in order to launch, run, execute, interpret or otherwise perform the instructions in management application 140-1 stored on computer readable storage medium 1112. Execution of the management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute management application 140-1.

In accordance with different examples, note that computer system may reside in any of various types of devices, including, but not limited to, a mobile computer, a personal computer system, wireless station, connection management resource, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein. In one example, the control system 1150 can include or be implemented in virtualization environments such as the cloud.

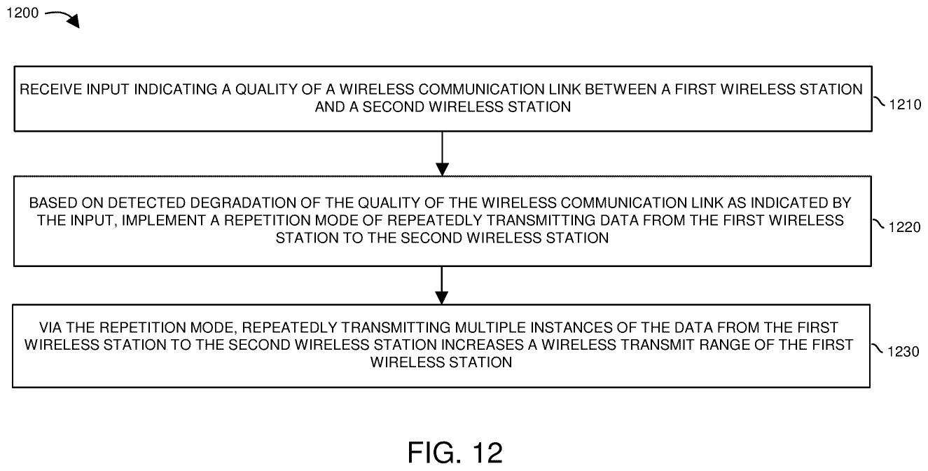

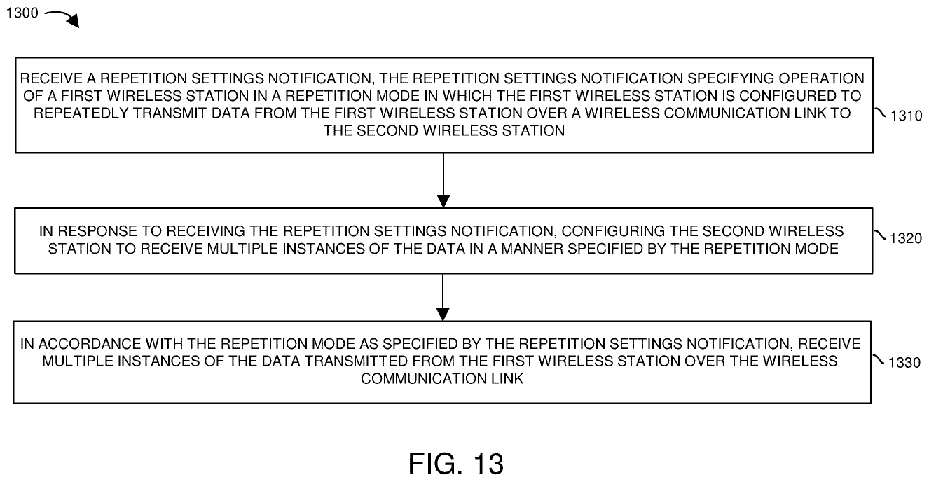

Functionality supported by the different resources will now be discussed via flowcharts in FIGS. 12 and 13. Note that the steps in the flowcharts below can be executed in any suitable order.

FIG. 12 is a flowchart 1200 illustrating an example method according to examples. Note that flowchart 1200 overlaps/captures general concepts as discussed herein.

In processing operation 1210, the first wireless station receives input indicating a quality of a wireless communication link between a first wireless station and a second wireless station.

In processing operation 1220, based on detected degradation of the quality of the wireless communication link as indicated by the input, the first wireless station implements a repetition mode of repeatedly transmitting data from the first wireless station to the second wireless station.

In processing operation 1230, via the repetition mode, the first wireless station repeatedly transmits multiple instances of the data from the first wireless station to the second wireless station, increasing a wireless transmit range of the first wireless station.

FIG. 13 is a flowchart 1300 illustrating an example method according to examples. Note that flowchart 1300 overlaps/captures general concepts as discussed herein.

In processing operation 1310, the second wireless station receives a repetition settings notification. The settings notification specifies operation of a first wireless station in a repetition mode in which the first wireless station is configured to repeatedly transmit multiple instances of data from the first wireless station over a wireless communication link to the second wireless station.

In processing operation 1320, in response to receiving the repetition settings notification, the second wireless station configures itself to receive the multiple instances of the data in a manner specified by the repetition mode.

In processing operation 1330, in accordance with the repetition mode as specified by the repetition settings notification, the second wireless station receives the multiple instances of the data transmitted from the first wireless station over the wireless communication link.

Note again that techniques herein are well suited to facilitate more efficient operation of providing network access to a mobile communication device via improved wireless range from the mobile communication device to another wireless station. However, it should be noted that examples herein are not limited to use in such applications and that the techniques discussed herein are well suited for other applications as well.

### Uplink Improvement Via Implementation of a Repetition Mode

The following analysis addresses link diversity, efficient estimation, and indirect effects on wireless transmit power.

The general analysis further discussed below frames the essence of the problem as a linear model estimation problem, which admits unbiased efficient estimators; note that this is not the same as seeking a linear estimator (sub-optimal).

The idea is to identify and expose a key optimality aspect vis-a-vis repetitions in accordance with the dynamic repetition mode as discussed herein—and in the particular context of ‘combining’ at a receiver wireless station via a coherency combination function—from the perspective of minimum variance unbiased (MVU) estimator(s), i.e., a class of unbiased estimators that do admit and achieve a lower bound on their variance, namely the Cramer Rao lower bound (CRLB) based on Fisher information matrix.

This view classifies diversity combining as a particular case of unbiased estimation—and exposes a mixture of scenarios in-between. The following discussion navigates between uncorrelated observations of a parameter to be estimated, e.g., uncorrelated fading coefficients, and correlated statistics-when identifying merits/gains in algorithms, or methods, or embodiments under discussion.

### Framing the Problem in the Form of the Linear Model

In this discussion, note that we interchangeably use terms like ‘diversity branch,’ or ‘repetition,’ or ‘(resolvable) diversity component,’ or simply ‘branch’ to refer to multiple observations of—or statistics for—some parameter (either deterministic or random) to be estimated. The intent is, via a coherency function as discussed herein, to ‘coherently’ and optimally combine such statistics—where optimality will be further defined.

In particular, the focus below is on how to enact (i.e., enable, or ‘induce’) multiple observations that can ultimately be combined (via a respective coherency function as described herein) in order to improve a sufficient statistic for at least one parameter. For example, assume that we observe some parameter s via M diversity branches, where each branch contributes a scalar gain rᵢ that models flat fading, i=1, . . . , M. This would be classic diversity combining, whereby the receiver wireless station receiving the repeated wireless signals (from a transmitter wireless station operating in the repetition mode) in the time domain, frequency domain, space domain, etc., uses the rᵢ scalars (or their conjugates, in the complex-valued case) as combining weights for the observations in the M branches-they are available as a result of channel estimation (cf. ‘single tap equalizer’ in OFDM).

In order to properly realize a ‘diversity gain,’ the gains rᵢ of the M diversity branches ought to be uncorrelated.

We show below that diversity combining is only one particular case of efficient estimation on the linear model, which is defined as

$$x = H θ + w$$

where x is a N×1 vector of observations or sufficient statistics, θ is a p×1 vector of parameters to be estimated, H is a N×p matrix of known parameters (for the single tap equalizer in the frequency domain these would be the branch gains, or their conjugates), and w is an N×1 vector of AWGN noise, w˜ [symbol] (0, σₙ²I_{N}).

This model is known to admit a MVU estimator: Error! Reference source not found.

$$\hat{θ} = {( {H}^{T} H )}^{- 1} {H}^{T} x$$

with covariance matrix

$${C}_{\hat{θ}} = {{σ}_{n}^{2} ( {H}^{T} H )}^{- 1}$$

This MVU estimator is efficient in the sense that it does achieve the CRLB, and the solution can be further generalized to coloured noise.

Note also that the improvement in the estimator's noise does not depend on the parameter (e.g., on the power of the data symbols—or transmit power—in the case when the parameter θ pertains to data symbols, cf. 0)

### Repetitions as a Linear Model Efficient Estimator Problem

It is noted that, without loss of generality, we can model the repetitions (from the wireless station operating in the repetition mode) at the subcarrier level—i.e., a symbol s is repeated on M subcarriers and observed M times at the receiver scaled by the flat channel coefficients, denoted rᵢ, on those subcarriers, i=1, . . . , M. These coefficients are available as a result of channel estimation. Obviously, repetition granularity can be a resource unit (RU), rather than just one subcarrier. Also, |s|² [symbol] 1.

Then the linear model applies with p=1, θ=s, N=M, H=[r₁, r₂, . . . , r_{M}]^{T}(H^{T}H)⁻¹=1/(Σᵢ₌₁^{M} rᵢ²) and the MVU estimate is:

$$\hat{s} = \frac{{\sum }_{i = 1}^{M} {r}_{i} {x}_{i}}{{\sum }_{i = 1}^{M} {r}_{i}^{2}} = \frac{{\sum }_{i = 1}^{M} ( {r}_{i}^{2} s + {r}_{i} {w}_{i} )}{{\sum }_{i = 1}^{M} {r}_{i}^{2}} = \frac{1}{{\sum }_{i = 1}^{M} {r}_{i}^{2}} ( {\sum }_{i = 1}^{M} ( {r}_{i}^{2} s ) + {\sum }_{i = 1}^{M} ( {r}_{i} {w}_{i} ) ) = \frac{1}{{\sum }_{i = 1}^{M} {r}_{i}^{2}} ( s {\sum }_{i = 1}^{M} {r}_{i}^{2} + {\sum }_{i = 1}^{M} ( {r}_{i} {w}_{i} ) )$$

The expression above can be viewed as an alternative statistic for s, asking the question of what its SNR is.

Note that this statistic (can be shown separately to be a sufficient statistic) is still noisy—albeit its noise has been reduced by a factor of Σᵢ₌₁^{M}rᵢ², according to the covariance matrix C_{\hat{θ}} above (degenerates to a scalar in this particular case; in fact, this is the CRLB, the minimum possible variance). Also note that we can use this statistic as a starting point for other methods to extract soft information (for demodulation, a posteriori probabilities, etc.), according to our receiver design needs (think, for example, of iterative receivers).

Returning to the SNR of this statistic, note that its noise component is Σᵢ₌₁^{M}(rᵢwᵢ), with variance σₙ²Σᵢ₌₁^{M}rᵢ²; its signal component is s Σᵢ₌₁^{M}rᵢ² and the factor (Σᵢ₌₁^{M}rᵢ²)⁻¹ obviously does not influence the SNR. The resulting SNR, denoted γ_{MVU}, is

$${γ}_{MVU} = \frac{{( s {\sum }_{i = 1}^{M} {r}_{i}^{2} )}^{2}}{{σ}_{n}^{2} {\sum }_{i = 1}^{M} {r}_{i}^{2}} = \frac{{\sum }_{i = 1}^{M} {r}_{i}^{2}}{{σ}_{n}^{2}}$$

This example (i) does not assume fading nor a narrowed setup like a receive array and (ii) allows us to state that the statistic's noise is, indeed, minimized in an optimal way. It remains conceptually abstract enough to be applied to a variety of problems. In one aspect, it can be particularized to diversity, efficient estimators, and all scenarios in-between. It also easily accommodates situations where |s|²≠1.

By this generalization we can be satisfied that repetitions achieve a measure of optimality, even in intermediate scenarios that do not qualify, e.g., as proper diversity. Claims from this perspective are sound. Repetitions from this point of view have a rigorous structure, that is flexible enough to handle various approaches on estimating s—that is, as a starting point for other methods to extract soft information (for demodulation, a posteriori probabilities, etc.), according to our needs (think for example of iterative receivers)

Note that the above improvement in statistic noise does not depend on the (time domain) transmit power assigned to s (see the expression for the estimator variance above, σₙ²/(Σᵢ₌₁^{M}rᵢ²), which reduces the noise variance by the sum branch energy, regardless of the energy in s).

### Further Discussion

This statistic lends itself to particular scenarios with special meaning.

### Diversity Combining

If rᵢ are uncorrelated flat fading coefficients—as would happen, e.g., with RUs spaced apart by more than one coherence bandwidth in the frequency domain-then Σᵢ₌₁^{M}rᵢ² becomes a central x-squared variable. It is easy to see that the probability density function concentrates around its mean, which becomes M times the mean of each term (the so-called ‘channel hardening’). This accumulation of the probability mass around its mean (in a central x-square variable) is in fact the essence of diversity combining. By a similar simple calculation, the SNR (in the sense of averages) can be seen to become γ_{MVU}=Mγ, an M-fold improvement, where γ is the SNR on one subcarrier (i.e., before any combining).

Deterministic case with equal gain branches rᵢ=r, ∀i=1, . . . , M

This is the conceptual opposite case of uncorrelated fading, and it is easy to verify that, again, optimality is maintained and γ_{MVU}=Mγ (cf. [symbol] )—i.e., an M-fold increase in the SNR of the statistic, despite there being no diversity in this case.

Note that, for more repetitions, where the SCS cannot be decreased arbitrarily in order to keep the transmit power constant, the repetitions will lead to increasing the transmit power; in that case, the repetition mode operates as a way to control wireless transmit power from the wireless station.

### CONCLUSION

This analysis establishes repetitions and the repetition mode as discussed herein as having sufficient structure to improve a link in wireless systems. Clearly it is applicable to a variety of wireless scenarios, from diversity gain to equal gain and including a mixture of scenarios in-between that cannot be characterized as ‘uncorrelated’ branches.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
receiving input indicating a quality of a wireless communication link between a first wireless station and a second wireless station; and
based on detected degradation of the quality of the wireless communication link as indicated by the input, implementing a repetition mode of repeatedly transmitting data from the first wireless station to the second wireless station.

2. The method as in claim 1 further comprising:
receiving the input from the second wireless station, the input notifying the first wireless station to operate in the repetition mode.

3. The method as in claim 1 further comprising:
producing the input at the first wireless station in response to an inability of the second wireless station to receive wireless signals from the first wireless station above a wireless power level.

4. The method as in claim 1, wherein the implemented repetition mode of repeatedly transmitting the data from the first wireless station to the second wireless station increases a wireless transmit range of the first wireless station.

5. The method as in claim 1, wherein implementing the repetition mode includes repeating transmission of the data over the wireless communication link in the time domain.

6. The method as in claim 5, wherein the repeated transmission of the data in the time domain includes:
in a first time duration, transmitting a first instance of the data over the wireless communication link from the first wireless station to the second wireless station; and
in a second time duration following the first time duration, transmitting a second instance of the data over the wireless communication link from the first wireless station to the second wireless station, wherein the second instance of the data is a replica of the first instance of the data.

7. The method as in claim 6, wherein the first instance of the data is transmitted over a first wireless bandwidth;
wherein the second instance of the data is transmitted over the first wireless bandwidth; and
wherein the first time duration and the second time duration reside within a single acquisition of the first wireless bandwidth by the first wireless station.

8. The method as in claim 6, wherein the first instance of the data is transmitted over a first wireless bandwidth;
wherein the second instance of the data is transmitted over the first wireless bandwidth;
wherein the first time duration resides within a first acquisition of the first wireless bandwidth by the first wireless station; and
wherein the second time duration resides within a second acquisition of the first wireless bandwidth by the first wireless station.

9. The method as in claim 1, wherein implementing the repetition mode includes repeating transmission of the data from the first wireless station over the wireless communication link in the frequency domain.

10. The method as in claim 9, wherein repeating transmission of the data in the frequency domain includes:
via a first wireless carrier frequency, transmitting a first instance of the data over the wireless communication link from the first wireless station to the second wireless station; and
via a second wireless carrier frequency different than the first wireless carrier frequency, transmitting a second instance of the data over the wireless communication link from the first wireless station to the second wireless station.

11. The method as in claim 1 further comprising:
transmitting a repetition settings notification from the first wireless station to the second wireless station, the repetition settings notification specifying how many instances in which the data is scheduled to be repeatedly transmitted from the first wireless station to the second wireless station via the repetition mode.

12. The method as in claim 11, wherein the repetition settings notification indicates that the first wireless station is configured to repeat transmission of the data in a single TXOP (Transmit Opportunity) acquired by the first wireless station.

13. The method as in claim 11, wherein the repetition settings notification indicates that the first wireless station is configured to repeat transmission of the data over multiple TXOPs (Transmit Opportunities) acquired by the first wireless station.

14. A system comprising:
communication management hardware operative to:
receive input indicating a quality of a wireless communication link between a first wireless station and a second wireless station; and
based on detected degradation of the quality of the wireless communication link as indicated by the input, implement a repetition mode of repeatedly transmitting data from the first wireless station to the second wireless station.

15. The system as in claim 14, wherein the communication management hardware is further operative to:
receive the input from the second wireless station, the input notifying the first wireless station to operate in the repetition mode.

16. The system as in claim 14, wherein the communication management hardware is further operative to:
produce the input at the first wireless station in response to an inability of the first wireless station to receive wireless signals from the second wireless station above a wireless power level.

17. The system as in claim 14, wherein the implemented repetition mode of repeatedly transmitting the data from the first wireless station to the second wireless station increases a wireless transmit range of the first wireless station.

18. The system as in claim 14, wherein the communication management hardware is further operative to:
repeat transmission of the data over the wireless communication link in the time domain.

19. The system as in claim 18, wherein the communication management hardware is further operative to:
in a first time duration, transmit a first instance of the data over the wireless communication link from the first wireless station to the second wireless station; and
in a second time duration following the first time duration, transmit a second instance of the data over the wireless communication link from the first wireless station to the second wireless station, wherein the second instance of the data is a replica of the first instance of the data.

20. The system as in claim 19, wherein the first instance of the data is transmitted over a first wireless bandwidth;
wherein the second instance of the data is transmitted over the first wireless bandwidth; and
wherein the first time duration and the second time duration reside within a single acquisition of the first wireless bandwidth by the first wireless station.

21. The system as in claim 19, wherein the first instance of the data is transmitted over a first wireless bandwidth;
wherein the second instance of the data is transmitted over the first wireless bandwidth;
wherein the first time duration resides within a first acquisition of the first wireless bandwidth by the first wireless station; and
wherein the second time duration resides within a second acquisition of the first wireless bandwidth by the first wireless station.

22. The system as in claim 14, wherein the communication management hardware is further operative to:
repeat transmission of the data from the first wireless station over the wireless communication link in the frequency domain.

23. The system as in claim 14, wherein the communication management hardware is further operative to:
via a first wireless carrier frequency, transmit a first instance of the data over the wireless communication link from the first wireless station to the second wireless station; and
via a second wireless carrier frequency different than the first wireless carrier frequency, transmit a second instance of the data over the wireless communication link from the first wireless station to the second wireless station.

24. The system as in claim 14, wherein the communication management hardware is further operative to:
transmit a repetition settings notification from the first wireless station to the second wireless station, the repetition settings notification specifying how many instances in which the data is scheduled to be repeatedly transmitted from the first wireless station to the second wireless station via the repetition mode.

25. The system as in claim 24, wherein the repetition settings notification indicates that the first wireless station is configured to repeat transmission of the data in a single TXOP (Transmit Opportunity) acquired by the first wireless station.

26-59. (canceled)
